(19) United States
(12) Patent Application Publication
(10) Pub. No.: US 2025/0199537 A1
(43) Pub. Date: Jun. 19, 2025

(54) SYSTEM AND METHOD FOR DETERMINING A RETURN-TO-HOME MAP

(71) Applicant: XTEND REALITY EXPANSION LTD., Tel Aviv (IL)

(72) Inventors: Vittorio Zaidman, Rehovot (IL); Erez Nehama, Ramat Gan (IL); Vladmir Froimchuck, Ramat Gan (IL); Reuven Rubi Liani, Rosh Haayin (IL); Aviv Shapira, Tel Aviv (IL); Lilach Bitton, Nesher (IL); Ido Abergel, Ramat Gan (IL); Omer Zetlawi, Lehavim (IL)

(73) Assignee: XTEND REALITY EXPANSION LTD., Tel Aviv (IL)

(21) Appl. No.: 18/978,283

(22) Filed: Dec. 12, 2024

Related U.S. Application Data
(60) Provisional application No. 63/609,355, filed on Dec. 13, 2023.

(51) Int. Cl. G05D 1/246; G05D 1/247; G05D 1/85

(52) U.S. Cl. CPC G05D 1/2469; G05D 1/247; G05D 1/85

(57) ABSTRACT

Embodiments of the present disclosure may include a system for lossy optimization of a return-to-home route, the system including a non-volatile memory. Embodiments may also include a wireless transceiver. Embodiments may also include a processor in communication with a non-volatile memory including a processor-readable media having thereon a set of executable instructions, configured, when executed, to cause the processor to receive via the wireless transceiver of coordinate samples (kn) over a time interval. In some embodiments, each coordinate sample may include at least two-dimensional pairs (x,y) and a vehicle yaw, the two-dimensional pairs (x,y) indicative of a pilot-assisted vehicle path over the time interval. Embodiments may also include identify a first coordinate pair of interest (x0,y0) and yaw0, a subsequent second coordinate pair (x1,y1), and a third subsequent coordinate pair (x2,y2) and yaw2.

### PRIORITY CLAIM

This application is a non-provisional to U.S. provisional patent application Ser. No. 63/609,355, titled SYSTEM AND METHOD FOR DETERMINING A RETURN-TO-HOME MAP, filed on Dec. 13, 2023, the contents of which are incorporated in its entirety by this reference.

### TECHNICAL FIELD

The subject matter disclosed herein relates, generally, to lossy optimization techniques for route management, specifically for systems and methods designed to compute efficient return-to-home routes for autonomous or pilot-assisted vehicles. More particularly, it concerns systems and methods employing non-volatile memory, wireless communication, and advanced vector and yaw analysis to deduplicate redundant coordinate data, optimize route points of interest, and generate efficient trajectories while minimizing data storage and computational overhead. The subject matter also encompasses closed-loop trajectory identification, data simplification through angle congruence analysis, and integration with user interfaces to enhance usability and functionality in route planning and execution.

### BRIEF SUMMARY

Embodiments of the present disclosure may include a system for lossy optimization of a return-to-home route, the system including a non-volatile memory. Embodiments may also include a wireless transceiver. Embodiments may also include a processor in communication with a non-volatile memory including a processor-readable media having thereon a set of executable instructions, configured, when executed, to cause the processor to receive via the wireless transceiver of coordinate samples (kn) over a time interval.

In some embodiments, each coordinate sample may include at least two-dimensional pairs (x,y) and a vehicle yaw, the two-dimensional pairs (x,y) indicative of a pilot-assisted vehicle path over the time interval. Embodiments may also include identify a first coordinate pair of interest (x0,y0) and yaw0, a subsequent second coordinate pair (x1,y1), and a third subsequent coordinate pair (x2,y2) and yaw2.

Embodiments may also include calculate a first vector of interest V1 from the first coordinate pair of interest (x0,y0) and the subsequent second coordinate pair (x1,y1). Embodiments may also include calculate a candidate vector of interest V2 from the subsequent second coordinate pair (x1,y1) and the third subsequent coordinate pair (x2,y2). Embodiments may also include calculate an angle of congruence α between the first vector of interest and the candidate vector of interest V2. Embodiments may also include determine whether the angle of congruence α may be indicative of a large angle change.

Embodiments of the present disclosure may also include discarding the subsequent second coordinate pair (x1,y1).

Embodiments of the present disclosure may also include discarding the third subsequent coordinate pair (x2,y2) if the angle of congruence α may be not indicative of the large angle change and storing the first coordinate pair of interest (x0,y0) as a last coordinate sample of interest and yaw0 as a last yaw of interest in the non-volatile memory.

Embodiments of the present disclosure may also include storing change in the non-volatile memory the third subsequent coordinate pair (x2,y2) as a last coordinate sample of interest and yaw2 as a last yaw of interest if the angle of congruence α may be indicative of the large angle. Embodiments may also include compare the last yaw of interest to a subsequent yawn associated with a subsequent coordinate pair of interest (xn,yn) to determine whether a yaw condition may be met.

Embodiments of the present disclosure may also include discard the subsequent coordinate pair of interest (xn,yn) and subsequent yawn if the condition may be not met and retrieve a subsequent yawn+1 associated with a subsequent coordinate pair of interest (xn+1,yn+1).

Embodiments of the present disclosure may also include store in the non-volatile memory the yawn associated with the subsequent coordinate pair of interest (xn,yn) as a new coordinate sample of interest and yawn as a new last yaw of interest if the condition may be met.

Embodiments of the present disclosure may also include, the system of claim 1, further including instructions to deduplicate a redundant coordinate sample over the time interval.

Embodiments of the present disclosure may also include, the system of claim 2. In some embodiments, the instructions to deduplicate a redundant coordinate sample over the time interval may include discarding the subsequent second coordinate pair (x1,y1) when the first coordinate pair of interest (x0,y0) may be approximately equal to the subsequent second coordinate pair (x1,y1) within a predetermined deviation.

Embodiments of the present disclosure may also include, the system of claim 3. In some embodiments, a predetermined deviation may be within a sensor tolerance.

Embodiments of the present disclosure may also include, the system of claim 1. In some embodiments, a route of coordinate samples (kn) may be based at least in part on a location position sample rate over the time interval. In some embodiments, the system, may include instructions to store in memory a minimum number of points of interest based at least in part on dividing the time interval by the sample rate.

In some embodiments, the RF transceiver may be at least a selection of frequencies within an extremely low frequency (ELF) band of less than 4 KHz, a very low frequency (VLF) band between 3 KHz to 30 KHz, a low frequency (LF) band between 30 KHz to 300 KHz, a medium frequency (MF) band between 300 KHz to 3 MHz, a high frequency (HF) band between 3 MHz to 30 MHz, a very high frequency (VHF) band between 30 MHz to 300 MHz, an ultra-high frequency (UHF) band between 300 MHz to 3 GHZ, a super high frequency (SHF) band between 3 GHz to 30 GHz, and an extremely high frequency (SHF) band between 30 GHz to 300 GHz.

Embodiments may also include a RF transceiver may be a cellular transceiver. Embodiments may also include a RF transceiver may be a Wi-Fi transceiver, or RF transceiver. In some embodiments, the instruction to calculate an angle of congruence α between the first vector of interest V1 and the candidate vector of interest V2 may include instructions to determine whether the angle of congruence α may be within a range of congruence.

Embodiments of the present disclosure may also include, the system of claim 2. In some embodiments, the instructions for deduplicating a redundant coordinate sample over the time interval may include detecting a user initiated hover in place command of a finite duration and discarding one or more coordinate pairs (xn,yn) during the time interval.

Embodiments of the present disclosure may also include, the system of claim 1. In some embodiments, the wireless transceiver may be a RF transceiver. Embodiments may also include a cellular transceiver may be 2G transceiver, a 3G transceiver, a 4G transceiver, a 5G transceiver, an LTE transceiver, or a 6G transceiver.

Embodiments of the present disclosure may also includea system configured with instructions for calculating a first vector of interest (V1) from an initial coordinate pair (x0, y0) and a subsequent coordinate pair (x1, y1). In some embodiments, the receive a route of coordinate samples (kn) over a time interval may be based at least in part on a pre-recorded pilot-assisted vehicle path over the time interval. In some embodiments, the range of congruence may be defined by.

In some embodiments, the instructions to calculate a first vector of interest V1 from the first coordinate pair of interest (x0,y0) and the subsequent second coordinate pair (x1,y1) may include b.

In some embodiments, the instruction to compare the last yaw of interest to a subsequent yawn associated with a subsequent coordinate pair of interest (xn,yn) to determine whether a yaw condition exceeds five decidegrees. Embodiments may also include store in the non-volatile memory the yawn associated with the subsequent coordinate pair of interest (xn,yn) as a new coordinate sample of interest and yawn as a new last yaw of interest if the condition may be met.

In some embodiments, the instruction to compare the last yaw of interest to a subsequent yawn associated with a subsequent coordinate pair of interest (xn,yn) to determine whether a yaw condition indicates a directional change. Embodiments may also include store in the non-volatile memory the yawn associated with the subsequent coordinate pair of interest (xn,yn) as a new coordinate sample of interest and yawn as a new last yaw of interest if the condition may be met.

In some embodiments, the yaw condition indicates a directional change in a horizontal plane of flight. In some embodiments, the yaw condition indicates a directional change in a horizontal plane of flight may include. Embodiments may also include receiving a buffer of user issued commands. In some embodiments, the buffer of user issued commands includes at least a time interval approximately between the last yaw of interest to the subsequent yawn associated with a subsequent coordinate pair of interest (xn,yn).

Embodiments may also include determining whether the yaw condition indicates a directional change in a horizontal plane of flight coincides with a user issued command indicative of the yaw condition. Embodiments may also include store in the non-volatile memory the yawn associated with the subsequent coordinate pair of interest (xn,yn) as a new coordinate sample of interest and yawn as a new last yaw of interest if the yaw condition coincides with the user issued command indicative of the yaw condition. In some embodiments, the yaw condition indicates a directional change in a vertical plane of flight.

Embodiments of the present disclosure may also include, the system of claim 1, further including an instruction to identify a closed loop trajectory. In some embodiments, the closed loop trajectory may include a starting coordinate pair (xs,ys) and ending coordinate pair (xe,ye), and a plurality of interceding coordinate pairs. Embodiments may also include store in memory the starting coordinate pair (xs,ys) as a point of interest. Embodiments may also include store in memory the ending coordinate pair (xe,ye) as a second point of interest. Embodiments may also include discard the plurality of interceding coordinate pairs.

Embodiments of the present disclosure may also include an instruction to store the first coordinate pair of interest and the new coordinate sample of interest to a point of interest dataset. In some embodiments, the system may include an instruction to identify a closed loop trajectory. In some embodiments, the closed loop trajectory may include a starting coordinate pair (xs,ys) and ending coordinate pair (xe,ye), and a plurality of interceding coordinate pairs. Embodiments may also include store in memory the starting coordinate pair (xs,ys) as a point of interest. Embodiments may also include store in memory the ending coordinate pair (xe,ye) as a second point of interest. Embodiments may also include discard the plurality of interceding coordinate pairs.

In some embodiments, the system may include an instruction to store the point of interest and the second point of interest to the point of interest dataset. In some embodiments, the system may include an instruction to generate a return-to-home map from the point of interest dataset. In some embodiments, the system may include an instruction to receive a user request for the return-to-home map from the point of interest dataset.

In some embodiments, the system may include an instruction to transmit the user request for the return-to-home map from the point of interest dataset to a drone. Embodiments may also include a route of coordinate samples (kn) may be based at least in part on a location position sample rate over the time interval. Embodiments may also include an instruction to store to the point of interest dataset a minimum number of points of interest based at least in part on dividing the time interval by the sample rate.

In some embodiments, the system may include an instruction to generate a return-to-home map from the point of interest dataset. In some embodiments, the system may include a user interface to receive a user request for the return-to-home map from the point of interest dataset. In some embodiments, the system may include an instruction to receive a user request for the return-to-home map from the point of interest dataset from the user interface. In some embodiments, the system may include an instruction to transmit the user request for the return-to-home map from the point of interest dataset to a drone.

Embodiments of the present disclosure may also include an instruction to transmit the user request for the return-to-home map from the point of interest dataset to a drone. In some embodiments, the system may include an instruction to determine whether a current drone position may be within a permissible range of deviation from an expected drone position along the optimized return to home map.

In some embodiments, the system may include an instruction to store the current drone position as a stable location when the current drone position may be within the permissible range of deviation from the expected drone position along the optimized return to home map. In some embodiments, the system may include an instruction to determine whether the current drone position exceeds a permissible range of deviation from an expected drone position along the optimized return to home map.

In some embodiments, the system may include an instruction to transmit a command to the drone to return to a stable location along the optimized return to home map. In some embodiments, the system may include an instruction to determine a current drone position may be the stable location along the optimized return to home map. Embodiments may also include an instruction to transmit a wait command. Embodiments may also include a wait command may include an instruction to hover or land.

Embodiments of the present disclosure may also include a method for lossy optimization of a return-to-home route, the method including receiving a route of coordinate samples (kn) over a time interval. In some embodiments, each coordinate sample may include at least two-dimensional pairs (x,y) and a vehicle yaw, the two-dimensional pairs (x,y) indicative of a pilot-assisted vehicle path over the time interval.

Embodiments may also include identifying a first coordinate pair of interest (x0,y0) and yaw0, a subsequent second coordinate pair (x1,y1), and a third subsequent coordinate pair (x2,y2) and yaw2. Embodiments may also include calculating a first vector of interest V1 from the first coordinate pair of interest (x0,y0) and the subsequent second coordinate pair (x1,y1).

Embodiments may also include calculating a candidate vector of interest V2 from the subsequent second coordinate pair (x1,y1) and the third subsequent coordinate pair (x2,y2). Embodiments may also include calculating an angle of congruence α a between the first vector of interest V1 and the candidate vector of interest V2. Embodiments may also include determining whether the angle of congruence α may be indicative of a large angle change.

Embodiments may also include discarding the subsequent second coordinate pair (x1,y1). Embodiments may also include discarding the third subsequent coordinate pair (x2,y2) if the angle of congruence α may be not indicative of the large angle change and storing the first coordinate pair of interest (x0,y0) as a last coordinate sample of interest and yaw as a last yaw of interest.

Embodiments may also include storing the third subsequent coordinate pair (x2,y2) as a last coordinate sample of interest and yaw2 as a last yaw of interest if the angle of congruence α may be indicative of the large angle change. Embodiments may also include comparing the last yaw of interest to a subsequent yawn associated with a subsequent coordinate pair of interest (xn,yn) to determine whether a yaw condition may be met.

Embodiments may also include discarding the subsequent coordinate pair of interest (xn,yn) and subsequent yawn if the condition may be not met and retrieving a subsequent yawn+1 associated with a subsequent coordinate pair of interest (xn+1,yn+1). Embodiments may also include storing the yawn associated with the subsequent coordinate pair of interest (xn,yn) as a new coordinate sample of interest and yawn as a new last yaw of interest if the condition may be met.

In some embodiments, the method may include deduplicating a redundant coordinate sample over the time interval. Embodiments may also include deduplicating a redundant coordinate sample over the time interval may include discarding the subsequent second coordinate pair (x1,y1) when the first coordinate pair of interest (x0,y0) may be approximately equal to the subsequent second coordinate pair (x1,y1) within a predetermined deviation.

Embodiments may also include a predetermined deviation may be within a sensor tolerance. In some embodiments, the method may include generating a return-to-home map from the point of interest dataset. In some embodiments, the method may include transmitting the user request for the return-to-home map from the point of interest dataset to a drone.

In some embodiments, the deduplicating a redundant coordinate sample over the time interval may include detecting a user initiated hover in place command of a finite duration and discarding one or more coordinate pairs (xn,yn) during the time interval. Embodiments may also include a route of coordinate samples (kn) may be based at least in part on a location position sample rate over the time interval.

In some embodiments, the method, may include storing in memory a minimum number of points of interest based at least in part on dividing the time interval by the sample rate. Embodiments may also include receiving a route of coordinate samples (kn) over a time interval may be received wirelessly. Embodiments may also include receiving a route of coordinate samples (kn) over a time interval may be received from a hardwire connect.

Embodiments may also include receiving a route of coordinate samples (kn) over a time interval may be received from a Ground Control System (GCS). In some embodiments, the method may include requesting the route of coordinate samples (kn) over a time interval may be received from a hardwire connect from a library of pre-recorded routes.

In some embodiments, the method may include receiving from a user interface a request for the route of coordinate samples (kn) over a time interval. In some embodiments, the method may include selecting from a user interface the route of coordinate samples (kn) over a time interval from a library of pre-recorded routes.

In some embodiments, the range of congruence may be defined by. Embodiments may also include calculating an angle of congruence α between the first vector of interest V1 and the candidate vector of interest V2 may include determining whether the angle of congruence α may be within a range of congruence. Embodiments may also include receiving a route of coordinate samples (kn) over a time interval may be based at least in part on a pre-recorded pilot-assisted vehicle path over the time interval.

Embodiments may also include calculating a first vector of interest V1 from the first coordinate pair of interest (x0,y0) and the subsequent second coordinate pair (x1,y1) may include b. Embodiments may also include comparing the last yaw of interest to a subsequent yawn associated with a subsequent coordinate pair of interest (xn,yn) to determine whether a yaw condition exceeds five decidegrees. Embodiments may also include storing in the non-volatile memory the yawn associated with the subsequent coordinate pair of interest (xn,yn) as a new coordinate sample of interest and yawn as a new last yaw of interest if the condition may be met.

In some embodiments, the method may include identifying a closed loop trajectory. In some embodiments, the closed loop trajectory may include a starting coordinate pair (xs,ys) and ending coordinate pair (xe,ye), and a plurality of interceding coordinate pairs. Embodiments may also include storing the starting coordinate pair (xs,ys) as a point of interest. Embodiments may also include storing the ending coordinate pair (xe,ye) as a second point of interest. Embodiments may also include discarding the plurality of interceding coordinate pairs.

In some embodiments, the method may include identifying a closed loop trajectory. In some embodiments, the closed loop trajectory may include a starting coordinate pair (xs,ys) and ending coordinate pair (xe,ye), and a plurality of interceding coordinate pairs. Embodiments may also include storing the starting coordinate pair (xs,ys) as a point of interest. Embodiments may also include storing in memory the ending coordinate pair (xe,ye) as a second point of interest. Embodiments may also include discarding the plurality of interceding coordinate pairs.

In some embodiments, the method may include storing the point of interest and the second point of interest to the point of interest dataset. In some embodiments, the method may include generating a return-to-home map from the point of interest dataset. In some embodiments, the method may include receiving a user request for the return-to-home map from the point of interest dataset.

In some embodiments, the method may include transmitting the user request for the return-to-home map from the point of interest dataset to a drone. Embodiments may also include a route of coordinate samples (kn) may be based at least in part on a location position sample rate over the time interval. Embodiments may also include an instruction to store to the point of interest dataset a minimum number of points of interest based at least in part on dividing the time interval by the sample rate. In some embodiments, the method may include receiving a user request for the return-to-home map from the point of interest dataset. In some embodiments, the method may include storing the first coordinate pair of interest and the new coordinate sample of interest to a point of interest dataset.

### BRIEF DESCRIPTION OF THE FIGURES

FIG. 1 is a block diagram illustrating a system, according to some embodiments of the present disclosure.

FIG. 2 is a block diagram illustrating store, according to some embodiments of the present disclosure.

FIG. 3 is a block diagram illustrating the system, according to some embodiments of the present disclosure.

FIG. 4 is a block diagram illustrating the system, according to some embodiments of the present disclosure.

FIG. 5 is a block diagram illustrating the system, according to some embodiments of the present disclosure.

FIG. 6 is a block diagram illustrating the system, according to some embodiments of the present disclosure.

FIG. 7 is a block diagram further illustrating the system from FIG. 6, according to some embodiments of the present disclosure.

FIG. 8 is a block diagram illustrating the system, according to some embodiments of the present disclosure.

FIG. 9 is a block diagram illustrating the system, according to some embodiments of the present disclosure.

FIG. 10 is a block diagram illustrating the system, according to some embodiments of the present disclosure.

FIG. 11 is a block diagram illustrating the system, according to some embodiments of the present disclosure.

FIG. 12 is a block diagram illustrating the system, according to some embodiments of the present disclosure.

FIG. 13 is a block diagram illustrating the system, according to some embodiments of the present disclosure.

FIG. 14 is a block diagram further illustrating the system from FIG. 13, according to some embodiments of the present disclosure.

FIG. 15 is a block diagram illustrating the system, according to some embodiments of the present disclosure.

FIG. 16 is a block diagram illustrating the system, according to some embodiments of the present disclosure.

FIG. 17 is a block diagram further illustrating the system from FIG. 16, according to some embodiments of the present disclosure.

FIG. 18 is a block diagram further illustrating the system from FIG. 16, according to some embodiments of the present disclosure.

FIG. 19 is a block diagram illustrating the system, according to some embodiments of the present disclosure.

FIG. 20 is a block diagram further illustrating the system from FIG. 19, according to some embodiments of the present disclosure.

FIG. 21 is a block diagram further illustrating the system from FIG. 19, according to some embodiments of the present disclosure.

FIG. 22A is a flowchart illustrating a method, according to some embodiments of the present disclosure.

FIG. 22B is a flowchart extending from FIG. 22A and further illustrating the method, according to some embodiments of the present disclosure.

FIG. 23 is a flowchart further illustrating the method from FIG. 22A, according to some embodiments of the present disclosure.

FIG. 24 is a flowchart further illustrating the method from FIG. 22A, according to some embodiments of the present disclosure.

FIG. 25A is a flowchart further illustrating the method from FIG. 22A, according to some embodiments of the present disclosure.

FIG. 25B is a flowchart extending from FIG. 25A and further illustrating the method, according to some embodiments of the present disclosure.

FIG. 26A is a flowchart further illustrating the method from FIG. 22A, according to some embodiments of the present disclosure.

FIG. 26B is a flowchart extending from FIG. 26A and further illustrating the method, according to some embodiments of the present disclosure.

FIG. 27A is a flowchart further illustrating the method from FIG. 22A, according to some embodiments of the present disclosure.

FIG. 27B is a flowchart extending from FIG. 27A and further illustrating the method, according to some embodiments of the present disclosure.

FIG. 28 is a flowchart further illustrating the method from FIG. 22A, according to some embodiments of the present disclosure.

FIG. 29A is an image of an original recorded return to home route.

FIG. 29B is an image of an optimized return to home map superimposed over an original recorded return to home route.

### DETAILED DESCRIPTION

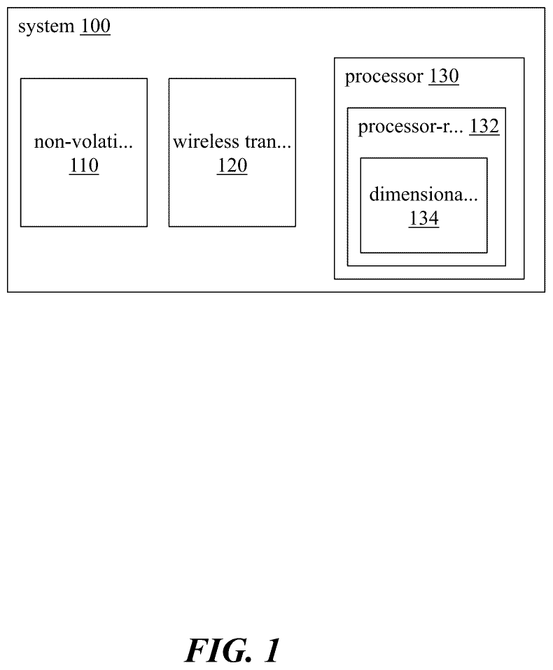

FIG. 1 is a block diagram that describes a system 100, according to some embodiments of the present disclosure. In some embodiments, the system 100 may include a non-volatile memory 110, a wireless transceiver 120, and a processor 130 in communication with a non-volatile memory. The processor 130 may include a processor-readable media 132. The processor-readable media 132 may also include at least two-dimensional pairs 134 (x,y) and a vehicle yaw, the two-dimensional pairs (x,y) indicative of a pilot-assisted vehicle path over the time interval.

In some embodiments, thereon a set of executable instructions, configured, when executed, to cause the processor 130 to receive via the wireless transceiver 120 of coordinate samples (kn) over a time interval. Each coordinate sample comprises. Identify a first coordinate pair of interest (x0,y0) and yaw0, a subsequent second coordinate pair (x1,y1), and a third subsequent coordinate pair (x2,y2) and yaw2. Instructions may also cause the processor 130 to calculate a first vector of interest V1 from the first coordinate pair of interest (x0,y0) and the subsequent second coordinate pair (x1,y1). Calculate a candidate vector of interest V2 from the subsequent second coordinate pair (x1,y1) and the third subsequent coordinate pair (x2,y2). Calculate an angle of congruence α between the first vector of interest and the candidate vector of interest V2. Determine whether the angle of congruence α may be indicative of a large angle change.

In some embodiments, discard the subsequent second coordinate pair (x1,y1).

In some embodiments, discard the third subsequent coordinate pair (x2,y2) if the angle of congruence α may be not indicative of the large angle change and storing the first coordinate pair of interest (x0,y0) as a last coordinate sample of interest and yaw0 as a last yaw of interest in the non-volatile memory.

In some embodiments, storing change in the non-volatile memory the third subsequent coordinate pair (x2,y2) as a last coordinate sample of interest and yaw2 as a last yaw of interest if the angle of congruence α may be indicative of the large angle. Compare the last yaw of interest to a subsequent yawn associated with a subsequent coordinate pair of interest (xn,yn) to determine whether a yaw condition may be met.

In some embodiments, discard the subsequent coordinate pair of interest (xn,yn) and subsequent yawn if the condition may be not met and retrieve a subsequent yawn+1 associated with a subsequent coordinate pair of interest (xn+1,yn+1).

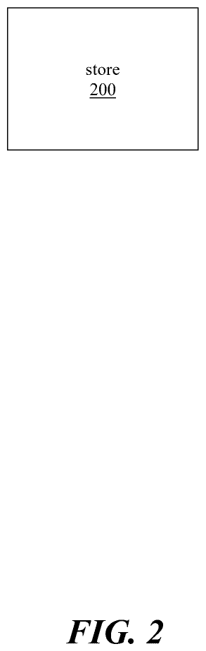

FIG. 2 is a block diagram that describes store 200, according to some embodiments of the present disclosure.

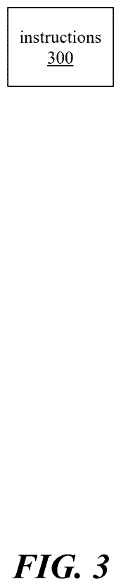

FIG. 3 is a block diagram that describes the system, according to some embodiments of the present disclosure. In some embodiments, the system of claim 1.

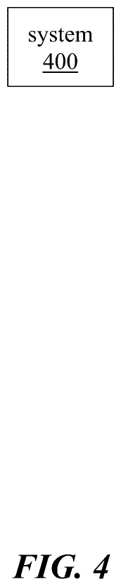

FIG. 4 is a block diagram that describes the system 400, according to some embodiments of the present disclosure. In some embodiments, the instructions to deduplicate a redundant coordinate sample over the time interval. Discarding the subsequent second coordinate pair (X1,y1) when the first coordinate pair of interest (x0,y0) may be approximately equal to the subsequent second coordinate pair (X1,y1) within a predetermined deviation.

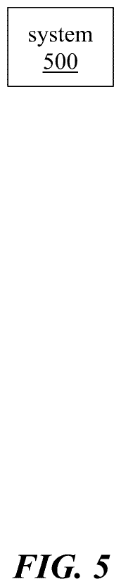

FIG. 5 is a block diagram that describes the system 500, according to some embodiments of the present disclosure. In some embodiments, a predetermined deviation may be within a sensor tolerance.

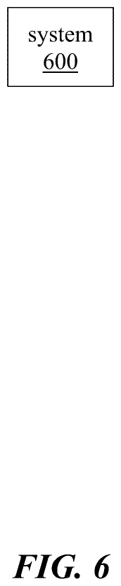

FIG. 6 is a block diagram that describes the system 600, according to some embodiments of the present disclosure. In some embodiments, a route of coordinate samples (kn) may be based at least in part on a location position sample rate over the time interval. In some embodiments, the RF transceiver may be at least a selection of frequencies within an extremely low frequency (ELF) band of less than 4 KHz, a very low frequency (VLF) band between 3 KHz to 30 KHz, a low frequency (LF) band between 30 KHz to 300 KHz, a medium frequency (MF) band between 300 KHz to 3 MHz, a high frequency (HF) band between 3 MHz to 30 MHZ, a very high frequency (VHF) band between 30 MHz to 300 MHz, an ultra-high frequency (UHF) band between 300 MHz to 3 GHZ, a super high frequency (SHF) band between 3 GHz to 30 GHZ, and an extremely high frequency (SHF) band between 30 GHz to 300 GHz. In some embodiments, a RF transceiver may be a cellular transceiver.

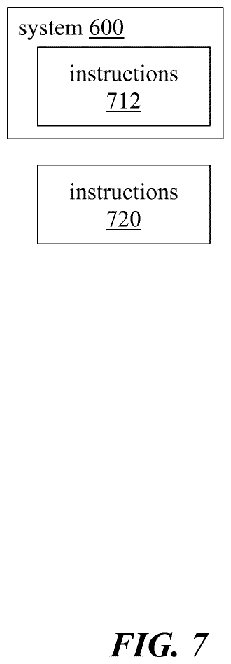

FIG. 7 is a block diagram that further describes the system 600 from FIG. 6, according to some embodiments of the present disclosure. In some embodiments, the system 600 may include instructions 712 to store in memory a minimum number of points of interest based at least in part on dividing the time interval by the sample rate. In some embodiments, a RF transceiver may be a Wi-Fi transceiver, or RF transceiver. In some embodiments, the instruction to calculate an angle of congruence α between the first vector of interest V1 and the candidate vector of interest V2.

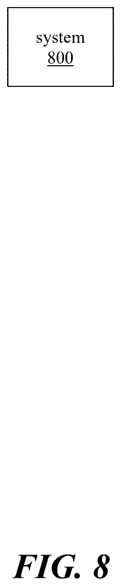

FIG. 8 is a block diagram that describes the system 800, according to some embodiments of the present disclosure. In some embodiments, the instructions for deduplicating a redundant coordinate sample over the time interval. Detecting a user initiated hover in place command of a finite duration and discarding one or more coordinate pairs (xn,yn) during the time interval.

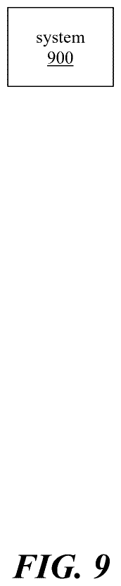

FIG. 9 is a block diagram that describes the system 900, according to some embodiments of the present disclosure. In some embodiments, the wireless transceiver may be a RF transceiver. In some embodiments, a cellular transceiver may be 2G transceiver, a 3G transceiver, a 4G transceiver, a 5G transceiver, an LTE transceiver, or a 6G transceiver.

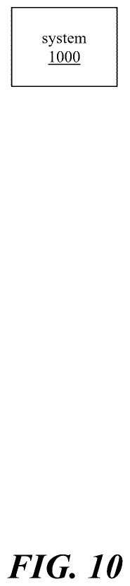

FIG. 10 is a block diagram that describes the system 1000, according to some embodiments of the present disclosure. In some embodiments, the receive a route of coordinate samples (kn) over a time interval may be based at least in part on a pre-recorded pilot-assisted vehicle path over the time interval. In some embodiments, the range of congruence may be defined by.

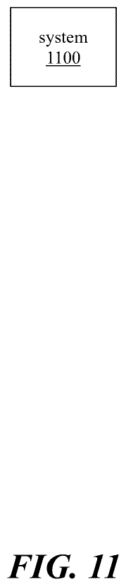

FIG. 11 is a block diagram that describes the system 1100, according to some embodiments of the present disclosure. In some embodiments, the instructions to calculate a first vector of interest V1 from the first coordinate pair of interest (x0,y0) and the subsequent second coordinate pair (x1,y1). B.

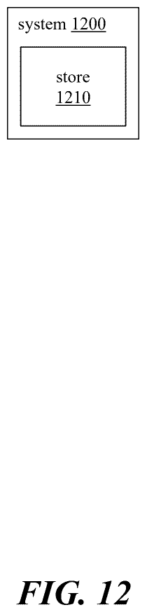

FIG. 12 is a block diagram that describes the system 1200, according to some embodiments of the present disclosure. In some embodiments, the system 1200 may also include store 1210 in the non-volatile memory the yawn associated with the subsequent coordinate pair of interest (xn,yn) as a new coordinate sample of interest and yawn as a new last yaw of interest if the condition may be met. The instruction to compare the last yaw of interest to a subsequent yaw associated with a subsequent coordinate pair of interest (xn,yn) to determine whether a yaw condition indicates a maneuver to deviate from the current flight path. A deviation from the current flight path can be detected by monitoring a degree of yaw. The degree of yaw may distinguish from minor corrections in the flight path, for example, a yaw of less than five decidegrees could indicate a minor correction, for example, a correction calculated by the drone to arrive at the pilot's intended destination in a mark and fly procedure. In some embodiments, a yaw between 5 decidegrees and 10 decidegrees could be a threshold range for determining a pilot's intent to change the trajectory of the system 1200.

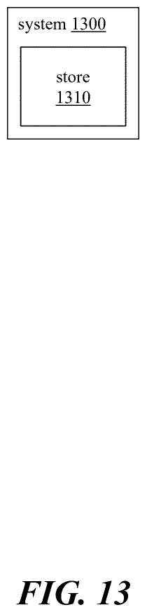

FIG. 13 is a block diagram that describes the system 1300, according to some embodiments of the present disclosure. In some embodiments, the system 1300 may also include store 1310 in the non-volatile memory the yawn associated with the subsequent coordinate pair of interest (xn,yn) as a new coordinate sample of interest and yawn as a new last yaw of interest if the condition may be met. The instruction to compare the last yaw of interest to a subsequent yawn associated with a subsequent coordinate pair of interest (xn,yn) to determine whether a yaw condition indicates a directional change. In some embodiments, the yaw condition may indicate a directional change in a horizontal plane of flight. In some embodiments, the yaw condition may indicate a directional change in a vertical plane of flight.

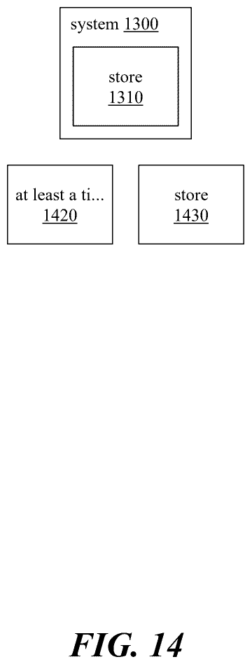

FIG. 14 is a block diagram that further describes the system 1300 from FIG. 13, according to some embodiments of the present disclosure. In some embodiments, the yaw condition may indicate a directional change in a horizontal plane of flight. Receiving a buffer of user issued commands. The buffer of user issued commands. Determining whether the yaw condition may indicate a directional change in a horizontal plane of flight coincides with a user issued command indicative of the yaw condition.

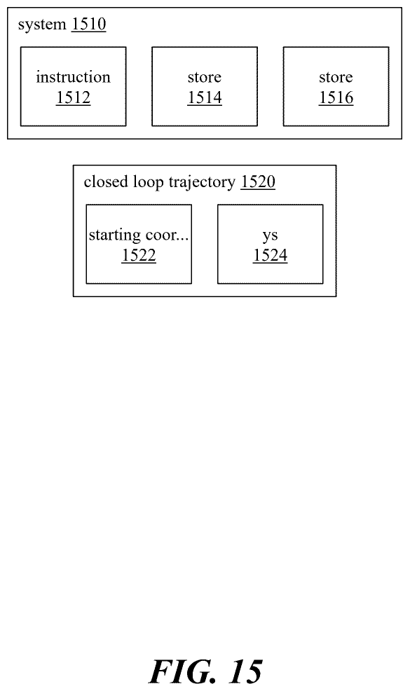

FIG. 15 is a block diagram that describes the system 1510, according to some embodiments of the present disclosure. In some embodiments, the system 1510 may include an instruction 1512 to identify a closed loop trajectory 1520. The system 1510 may also include store 1514 in memory the starting coordinate pair 1522 (xs,ys) as a point of interest. The system 1510 may also include store 1516 in memory the ending coordinate pair (xe,ye) as a second point of interest. Discard the plurality of interceding coordinate pairs. The closed loop trajectory 1520 may include a starting coordinate pair 1522 (xs. The closed loop trajectory 1520 may also include ys 1524) and ending coordinate pair (xe,ye), and a plurality of interceding coordinate pairs.

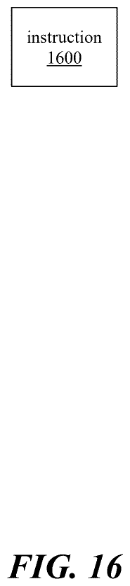

FIG. 16 is a block diagram that describes the system 1720, according to some embodiments of the present disclosure. In some embodiments, the system 1720 of claim 1.

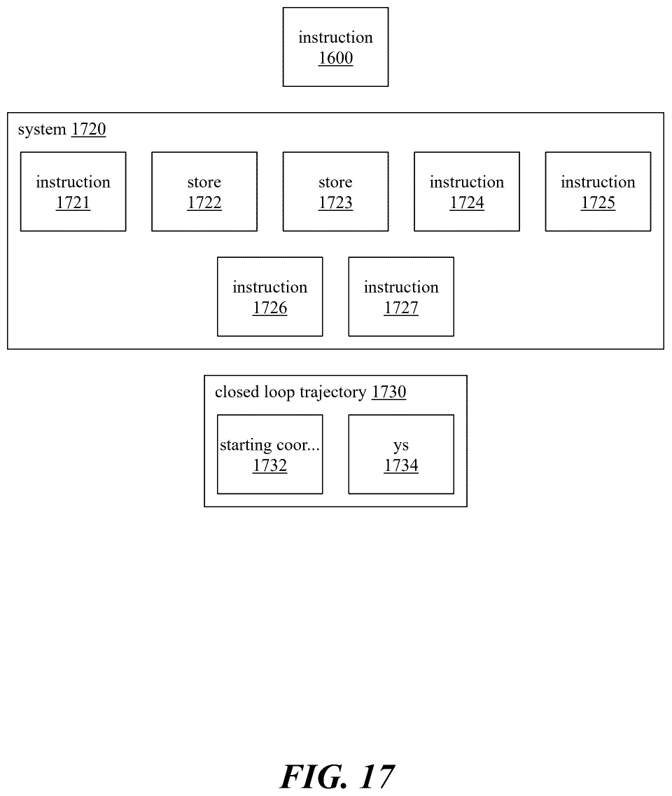

FIG. 17 is a block diagram that further describes the system 1720 from FIG. 16, according to some embodiments of the present disclosure. In some embodiments, the system 1720 may include an instruction 1721 to identify a closed loop trajectory 1730. The system 1720 may also include store 1722 in memory the starting coordinate pair 1732 (xs,ys) as a point of interest. The system 1720 may also include store 1723 in memory the ending coordinate pair (xe,ye) as a second point of interest. Discard the plurality of interceding coordinate pairs. The closed loop trajectory 1730 may include a starting coordinate pair 1732 (xs. The closed loop trajectory 1730 may also include ys 1734) and ending coordinate pair (xe,ye), and a plurality of interceding coordinate pairs.

In some embodiments, the system 1720 may include an instruction 1724 to store the point of interest and the second point of interest to the point of interest dataset. In some embodiments, the system 1720 may include an instruction 1725 to generate a return-to-home map from the point of interest dataset. In some embodiments, the system 1720 may include an instruction 1726 to receive a user request for the return-to-home map from the point of interest dataset. In some embodiments, the system 1720 may include an instruction 1727 to transmit the user request for the return-to-home map from the point of interest dataset to a drone.

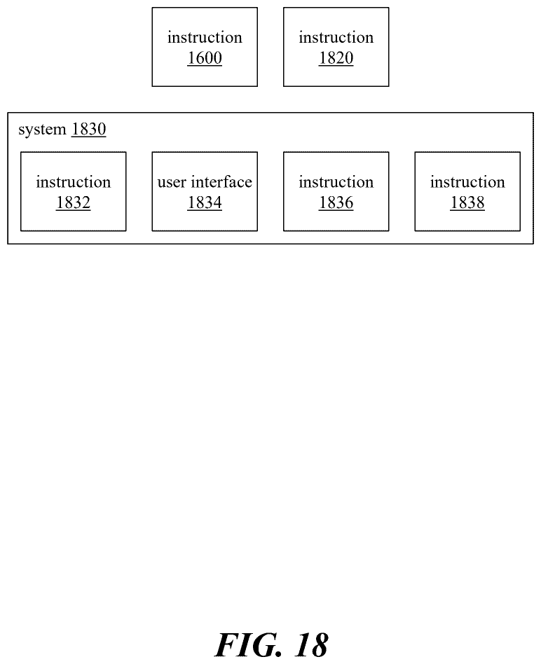

FIG. 18 is a block diagram that further describes the system 1720 from FIG. 16, according to some embodiments of the present disclosure. In some embodiments, a route of coordinate samples (kn) may be based at least in part on a location position sample rate over the time interval. In some embodiments, the system 1720 may include an instruction 1832 to generate a return-to-home map from the point of interest dataset. In some embodiments, the system 1720 may include a user interface 1834 to receive a user request for the return-to-home map from the point of interest dataset. In some embodiments, the system 1720 may include an instruction 1836 to receive a user request for the return-to-home map from the point of interest dataset from the user interface 1834. In some embodiments, the system 1720 may include an instruction 1838 to transmit the user request for the return-to-home map from the point of interest dataset to a drone.

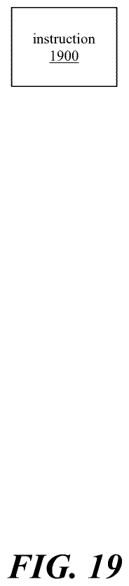

FIG. 19 is a block diagram that describes the system 2020, according to some embodiments of the present disclosure. In some embodiments, the system 2020 of claim 1.

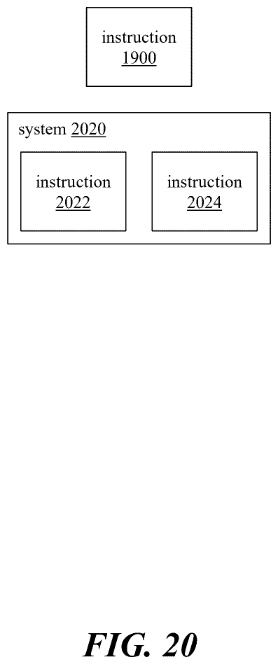

FIG. 20 is a block diagram that further describes the system 2020 from FIG. 19, according to some embodiments of the present disclosure. In some embodiments, the system 2020 may include an instruction 2022 to determine whether a current drone position may be within a permissible range of deviation from an expected drone position along the optimized return to home map. In some embodiments, the system 2020 may include an instruction 2024 to store the current drone position as a stable location when the current drone position may be within the permissible range of deviation from the expected drone position along the optimized return to home map.

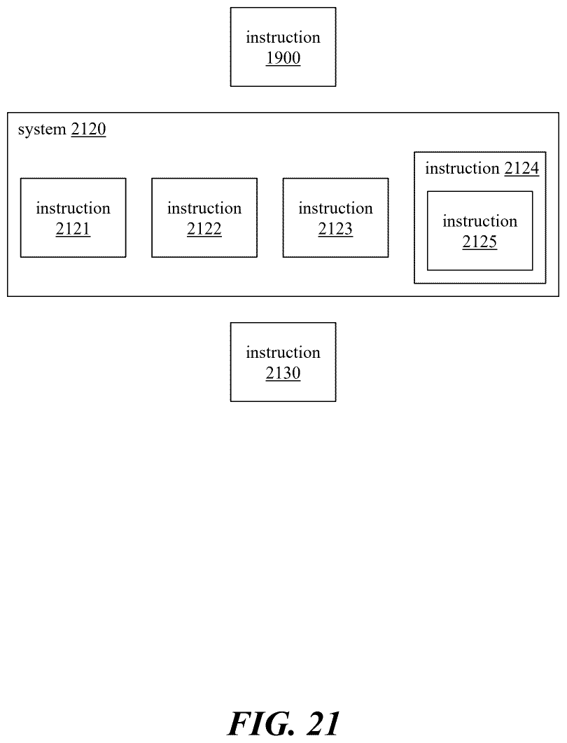

FIG. 21 is a block diagram that further describes the system 2020 from FIG. 19, according to some embodiments of the present disclosure. In some embodiments, the system 2020 may include an instruction 2022 to determine whether a current drone position may be within a permissible range of deviation from an expected drone position along the optimized return to home map. In some embodiments, the system 2020 may include an instruction 2122 to determine whether the current drone position exceeds a permissible range of deviation from an expected drone position along the optimized return to home map.

In some embodiments, the system 2020 may include an instruction 2123 to transmit a command to the drone to return to a stable location along the optimized return to home map. In some embodiments, the system 2020 may include an instruction 2124 to determine a current drone position may be the stable location along the optimized return to home map. The instruction 2124 may include an instruction 2125 to transmit a wait command. In some embodiments, a wait command.

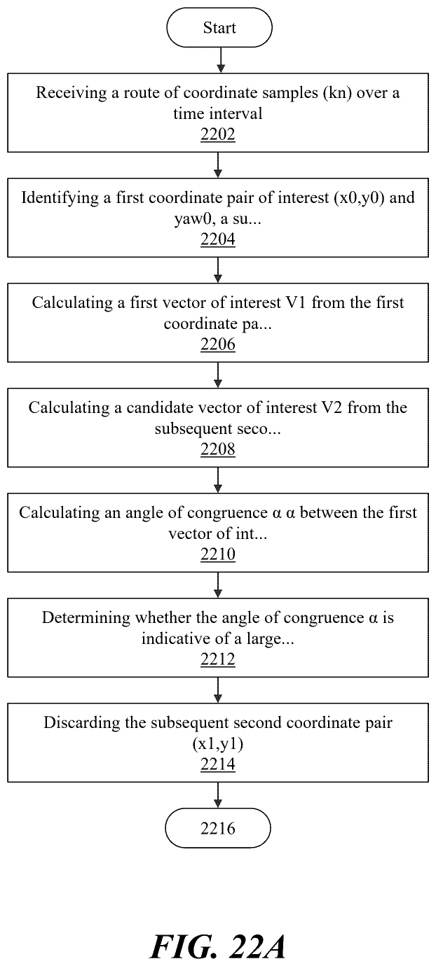

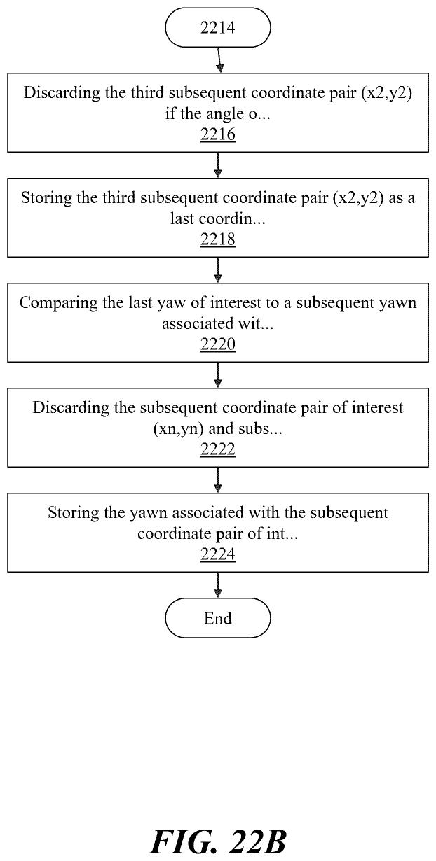

FIGS. 22A to 22B are flowcharts that describe a method, according to some embodiments of the present disclosure. In some embodiments, at 2202, the method may include receiving a route of coordinate samples (kn) over a time interval. At 2204, the method may include identifying a first coordinate pair of interest (x0,y0) and yaw0, a subsequent second coordinate pair (x1,y1), and a third subsequent coordinate pair (x2,y2) and yaw2. At 2206, the method may include calculating a first vector of interest V1 from the first coordinate pair of interest (x0,y0) and the subsequent second coordinate pair (x1,y1).

In some embodiments, at 2208, the method may include calculating a candidate vector of interest V2 from the subsequent second coordinate pair (x1,y1) and the third subsequent coordinate pair (x2,y2). At 2210, the method may include calculating an angle of congruence α a between the first vector of interest V1 and the candidate vector of interest V2. At 2212, the method may include determining whether the angle of congruence α may be indicative of a large angle change. At 2220, the method may include comparing the last yaw of interest to a subsequent yawn associated with a subsequent coordinate pair of interest (xn,yn) to determine whether a yaw condition may be met.

In some embodiments, each coordinate sample comprises at least two-dimensional pairs (x,y) and a vehicle yaw, the two-dimensional pairs (x,y) indicative of a pilot-assisted vehicle path over the time interval. At 2214, the determining may include discarding the subsequent second coordinate pair (x1,y1). At 2216, the determining may include discarding the third subsequent coordinate pair (x2,y2) if the angle of congruence α may be not indicative of the large angle change and storing the first coordinate pair of interest (x0,y0) as a last coordinate sample of interest and yaw0 as a last yaw of interest. At 2218, the determining may include storing the third subsequent coordinate pair (x2,y2) as a last coordinate sample of interest and yaw2 as a last yaw of interest if the angle of congruence α may be indicative of the large angle change.

In some embodiments, at 2222, the comparing may include discarding the subsequent coordinate pair of interest (xn,yn) and subsequent yawn if the condition may be not met and retrieving a subsequent yawn+1 associated with a subsequent coordinate pair of interest (xn+1,yn+1). At 2224, the comparing may include storing the yawn associated with the subsequent coordinate pair of interest (xn,yn) as a new coordinate sample of interest and yawn as a new last yaw of interest if the condition may be met.

In some embodiments, a predetermined deviation may be within a sensor tolerance. In some embodiments, the deduplicating a redundant coordinate sample over the time interval further comprises detecting a user initiated hover in place command of a finite duration and discarding one or more coordinate pairs (xn,yn) during the time interval. In some embodiments, a route of coordinate samples (kn) may be based at least in part on a location position sample rate over the time interval.

In some embodiments, the method may include storing in memory a minimum number of points of interest based at least in part on dividing the time interval by the sample rate. In some embodiments, receiving a route of coordinate samples (kn) over a time interval may be received wirelessly. In some embodiments, receiving a route of coordinate samples (kn) over a time interval may be received from a hardwire connect.

In some embodiments, receiving a route of coordinate samples (kn) over a time interval may be received from a Ground Control System (GCS). In some embodiments, the method may include requesting the route of coordinate samples (kn) over a time interval may be received from a hardwire connect from a library of pre-recorded routes. In some embodiments, calculating an angle of congruence α between the first vector of interest V1 and the candidate vector of interest V2 further comprises determining whether the angle of congruence α may be within a range of congruence.

In some embodiments, receiving a route of coordinate samples (kn) over a time interval may be based at least in part on a pre-recorded pilot-assisted vehicle path over the time interval. In some embodiments, calculating a first vector of interest V1 from the first coordinate pair of interest (x0,y0) and the subsequent second coordinate pair (x1,y1) further comprise, the method may include performing one or more additional steps. B. In some embodiments, comparing the last yaw of interest to a subsequent yawn associated with a subsequent coordinate pair of interest (xn,yn) to determine whether a yaw condition exceeds five decidegrees. In some embodiments, the method may include storing the first coordinate pair of interest and the new coordinate sample of interest to a point of interest dataset.

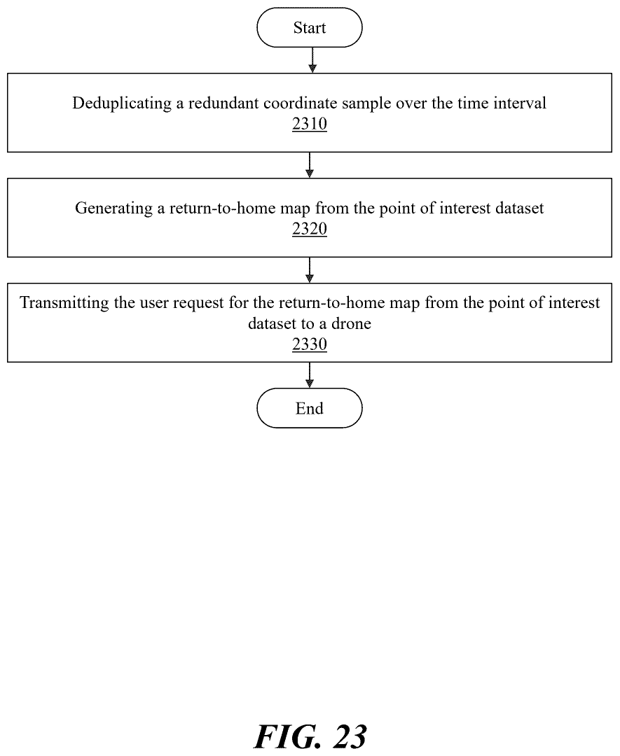

FIG. 23 is a flowchart that further describes the method from FIG. 22A, according to some embodiments of the present disclosure. In some embodiments, at 2310, the method may include deduplicating a redundant coordinate sample over the time interval. In some embodiments, deduplicating a redundant coordinate sample over the time interval may further comprise discarding the subsequent second coordinate pair (x1,y1) when the first coordinate pair of interest (x0,y0) may be approximately equal to the subsequent second coordinate pair (x1,y1) within a predetermined deviation. In some embodiments, at 2320, the method may include generating a return-to-home map from the point of interest dataset. In some embodiments, at 2330, the method may include transmitting the user request for the return-to-home map from the point of interest dataset to a drone.

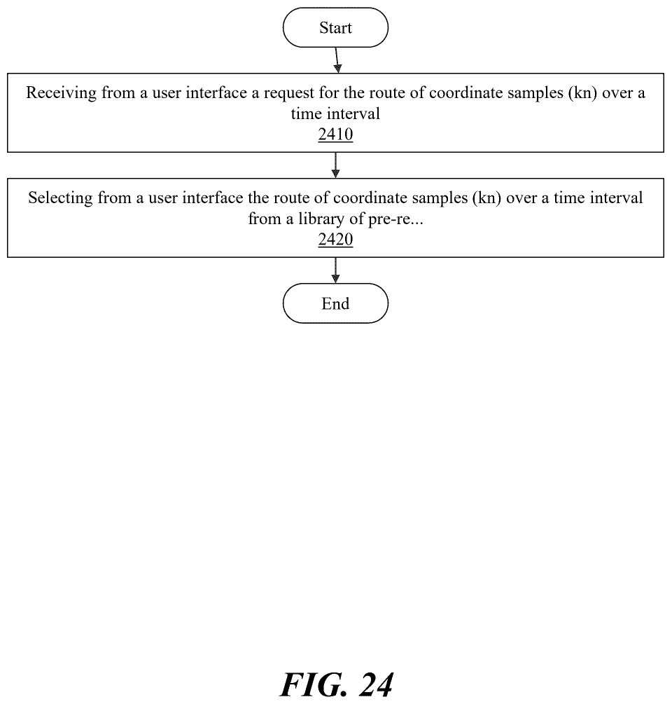

FIG. 24 is a flowchart that further describes the method from FIG. 22A, according to some embodiments of the present disclosure. In some embodiments, at 2410, the method may include receiving from a user interface a request for the route of coordinate samples (kn) over a time interval. In some embodiments, at 2420, the method may include selecting from a user interface the route of coordinate samples (kn) over a time interval from a library of pre-recorded routes. In some embodiments, the range of congruence may be defined by.

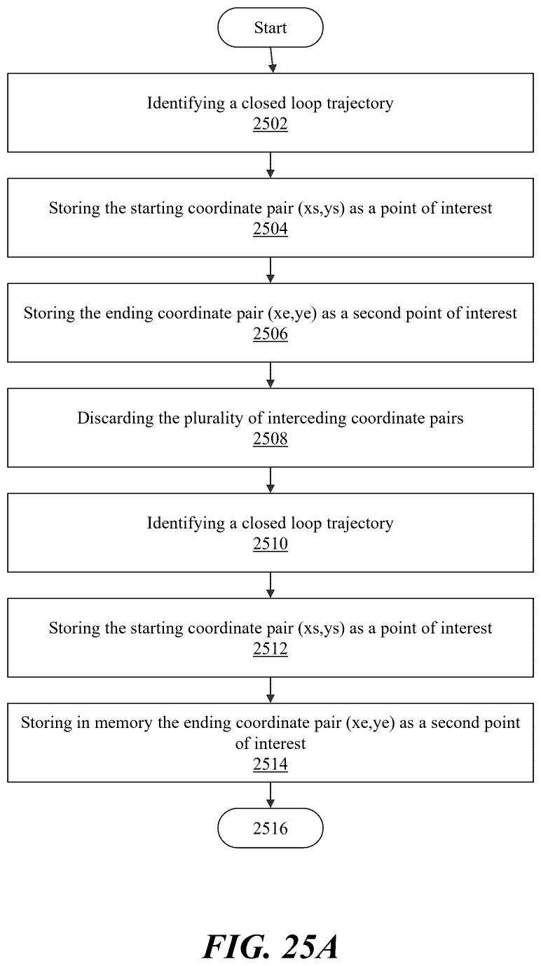

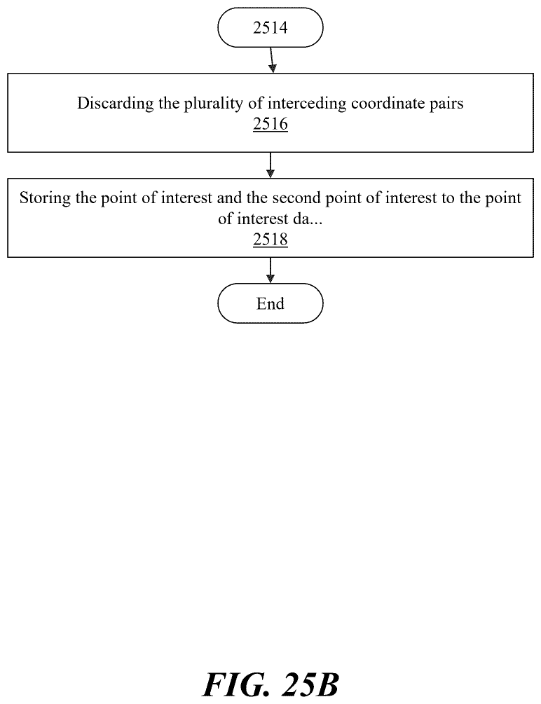

FIGS. 25A to 25B are flowcharts that further describe the method from FIG. 22A, according to some embodiments of the present disclosure. In some embodiments, at 2502, the method may include identifying a closed loop trajectory. At 2504, the method may include storing the starting coordinate pair (xs,ys) as a point of interest. At 2506, the method may include storing the ending coordinate pair (xe,ye) as a second point of interest. At 2508, the method may include discarding the plurality of interceding coordinate pairs. The closed loop trajectory may comprise a starting coordinate pair (xs,ys) and ending coordinate pair (xe,ye), and a plurality of interceding coordinate pairs.

In some embodiments, at 2510, the method may include identifying a closed loop trajectory. At 2512, the method may include storing the starting coordinate pair (xs,ys) as a point of interest. At 2514, the method may include storing in memory the ending coordinate pair (xe,ye) as a second point of interest. At 2516, the method may include discarding the plurality of interceding coordinate pairs. The closed loop trajectory may comprise a starting coordinate pair (xs,ys) and ending coordinate pair (xe,ye), and a plurality of interceding coordinate pairs. In some embodiments, at 2518, the method may include storing the point of interest and the second point of interest to the point of interest dataset.

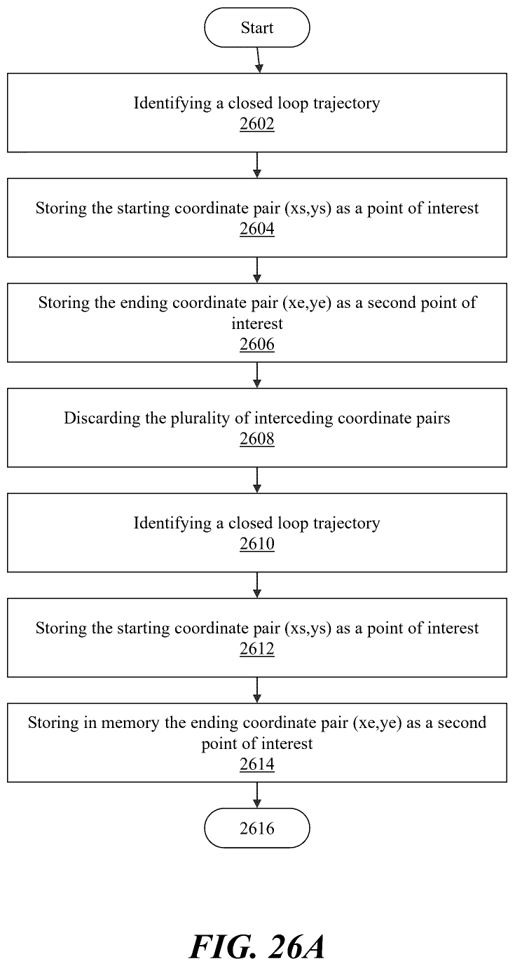

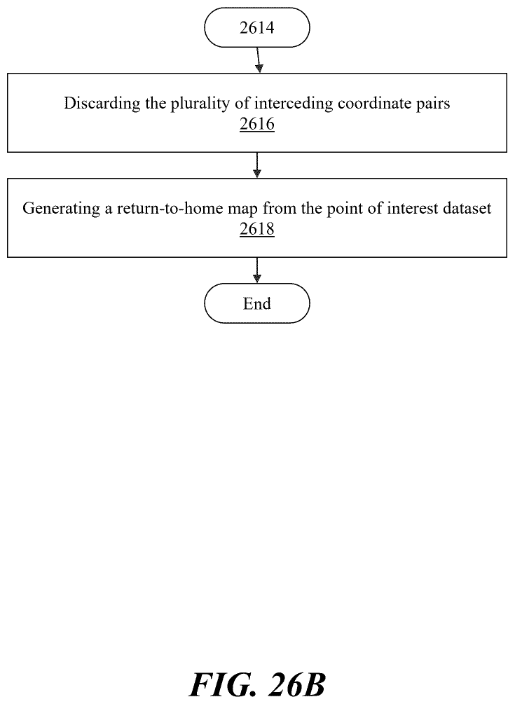

FIGS. 26A to 26B are flowcharts that further describe the method from FIG. 22A, according to some embodiments of the present disclosure. In some embodiments, at 2502, the method may include identifying a closed loop trajectory. At 2504, the method may include storing the starting coordinate pair (xs,ys) as a point of interest. At 2506, the method may include storing the ending coordinate pair (xe,ye) as a second point of interest. At 2508, the method may include discarding the plurality of interceding coordinate pairs. The closed loop trajectory may comprise a starting coordinate pair (xs,ys) and ending coordinate pair (xe,ye), and a plurality of interceding coordinate pairs.

In some embodiments, at 2510, the method may include identifying a closed loop trajectory. At 2512, the method may include storing the starting coordinate pair (xs,ys) as a point of interest. At 2514, the method may include storing in memory the ending coordinate pair (xe,ye) as a second point of interest. At 2516, the method may include discarding the plurality of interceding coordinate pairs. The closed loop trajectory may comprise a starting coordinate pair (xs,ys) and ending coordinate pair (xe,ye), and a plurality of interceding coordinate pairs. In some embodiments, at 2618, the method may include generating a return-to-home map from the point of interest dataset.

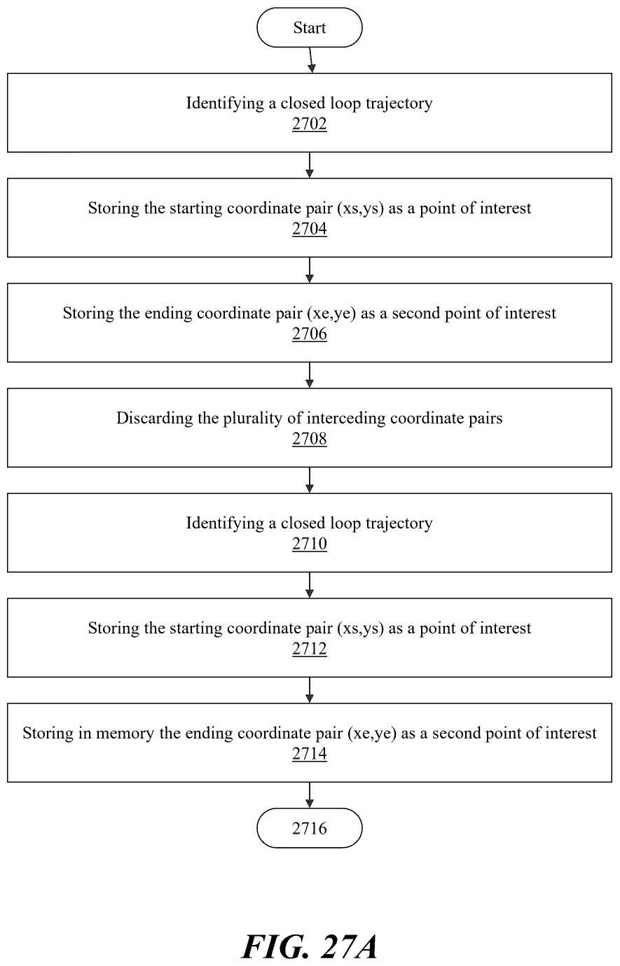

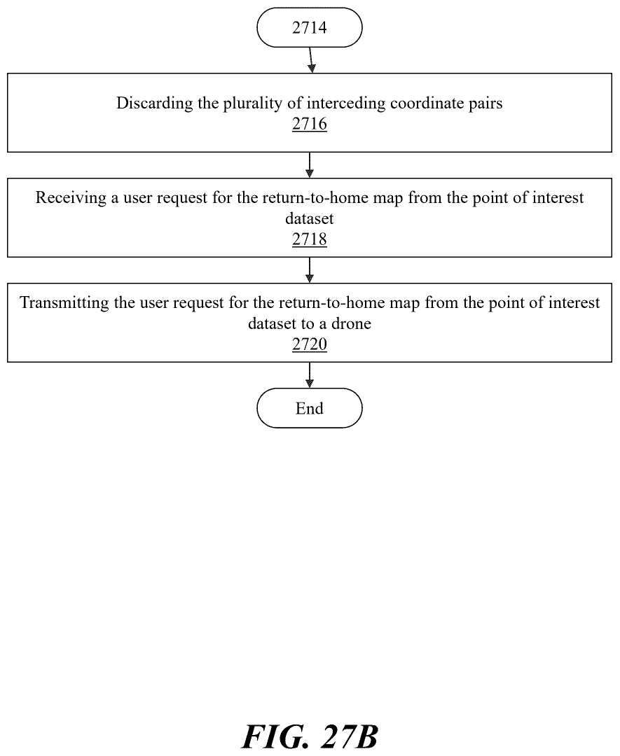

FIGS. 27A to 27B are flowcharts that further describe the method from FIG. 22A, according to some embodiments of the present disclosure. In some embodiments, at 2502, the method may include identifying a closed loop trajectory. At 2504, the method may include storing the starting coordinate pair (xs,ys) as a point of interest. At 2506, the method may include storing the ending coordinate pair (xe,ye) as a second point of interest. At 2508, the method may include discarding the plurality of interceding coordinate pairs. The closed loop trajectory may comprise a starting coordinate pair (xs,ys) and ending coordinate pair (xe,ye), and a plurality of interceding coordinate pairs.

In some embodiments, at 2510, the method may include identifying a closed loop trajectory. At 2512, the method may include storing the starting coordinate pair (xs,ys) as a point of interest. At 2514, the method may include storing in memory the ending coordinate pair (xe,ye) as a second point of interest. At 2516, the method may include discarding the plurality of interceding coordinate pairs. The closed loop trajectory may comprise a starting coordinate pair (xs,ys) and ending coordinate pair (xe,ye), and a plurality of interceding coordinate pairs. In some embodiments, at 2718, the method may include receiving a user request for the return-to-home map from the point of interest dataset. In some embodiments, at 2720, the method may include transmitting the user request for the return-to-home map from the point of interest dataset to a drone.

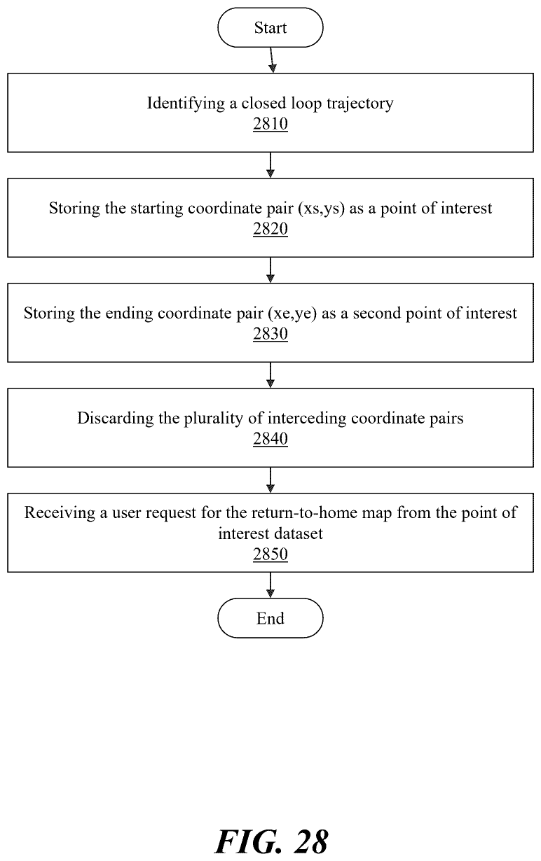

FIG. 28 is a flowchart that further describes the method from FIG. 22A, according to some embodiments of the present disclosure. In some embodiments, at 2502, the method may include identifying a closed loop trajectory. At 2504, the method may include storing the starting coordinate pair (xs,ys) as a point of interest. At 2506, the method may include storing the ending coordinate pair (xe,ye) as a second point of interest. At 2508, the method may include discarding the plurality of interceding coordinate pairs. The closed loop trajectory may comprise a starting coordinate pair (xs,ys) and ending coordinate pair (xe,ye), and a plurality of interceding coordinate pairs.

In some embodiments, a route of coordinate samples (kn) may be based at least in part on a location position sample rate over the time interval. An instruction to store to the point of interest dataset a minimum number of points of interest based at least in part on dividing the time interval by the sample rate. In some embodiments, at 2850, the method may include receiving a user request for the return-to-home map from the point of interest dataset.

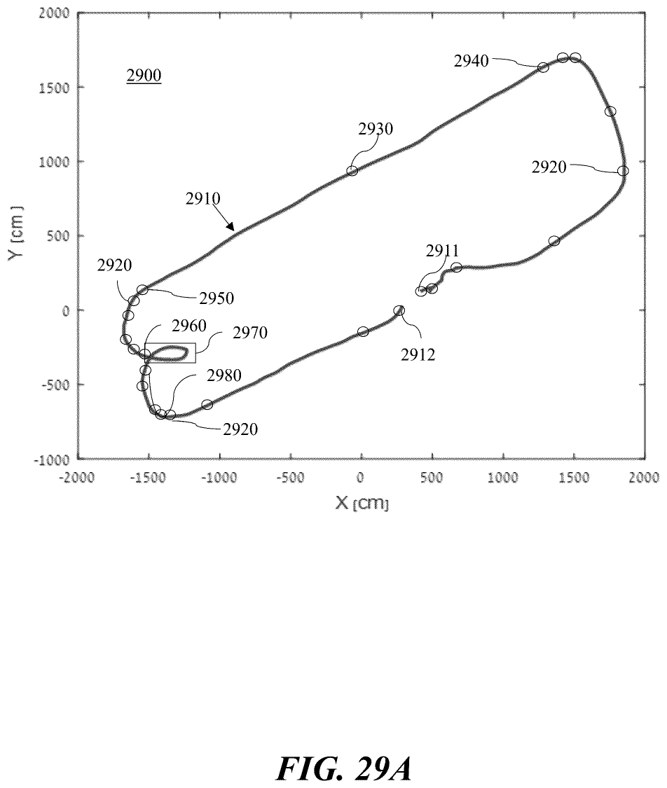

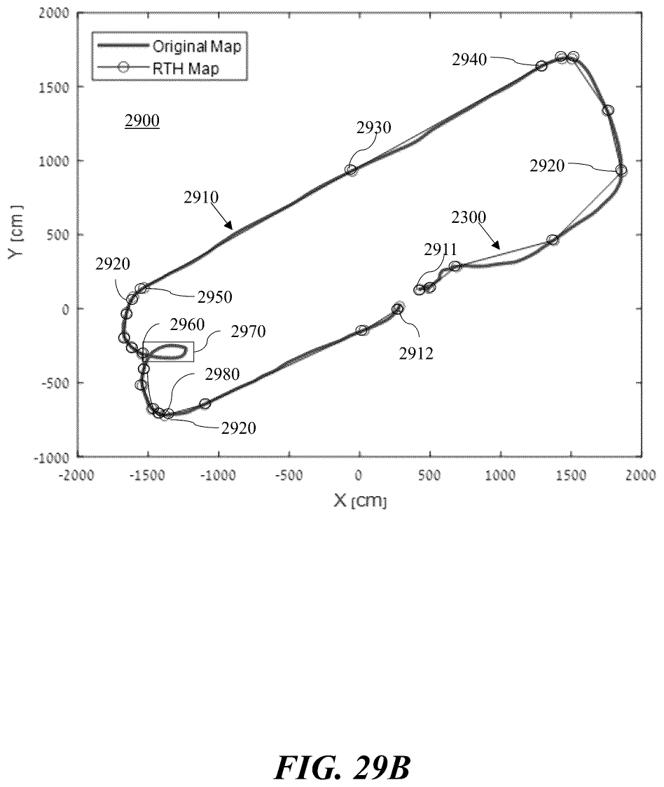

FIG. 29A is an image 2200 of an original recorded return to home route 2910 from an unmanned aerial vehicle piloted by a user. The return to home route may include a several points of interest 2911, 2912, 2920, 2930, 2940, and 2950. Each of the points of interest 2911, 2912, 2920, 2930, 2940, and 2950 may include an x coordinate and y coordinate along with a recorded yaw of the unmanned vehicle points. Each of the points of interest 2920 denote a change in trajectory in the piloted flight path 2910. These points of interest may include a turning point 2900 and an automatically stored point 2930. The automatically stored point may be determined by selecting a mid-point point of interest 2930 between a straight line trajectory starting point 2940 and a straight line ending point 2950. Such a mid-point point of interest 2930 can be useful in minimizing drift in an instruction set to traverse the distance from the straight-line trajectory starting point 2940 and the straight-line ending point 2950. The mid-point of interest 2930 allows other interceding points to be discarded. important coordinates online and save them. The reason to avoid redundancies is the storage space needed to store all the coordinates recorded while in flight. During flight, a sample rate of around 50 samples per second (50 Hz), during a six minutes flight time can reach roughly 18,000 different samples per each of the x and y-axis. By storing only the points of interest to memory, a much smaller sample size is needed to support a pilot in returning the unmanned vehicle to the starting point of interest 2911.

While several points of interest 2911, 2912, 2920, 2930, 2940, and 2950 may exist on the piloted flight path 2910. One such region may include a piloted change in trajectory instruction, for example a closed loop trajectory feature 2970. A closed loop trajectory feature may be defined by a starting coordinate pair (xs,ys) defining a starting point of interest 2960 and an ending coordinate pair (xe,ye) defining the second point of interest 2980 of the closed loop trajectory. By identifying the starting point of interest 2960 and second point of interest 2980, and discarding the plurality of interceding coordinate pairs, the memory required to store a suitable flight path can be reduced. Discarding the plurality of interceding coordinate pairs may also be used to optimize the flight time of the return to home route, such as the one depicted in FIG. 29B.

FIG. 29B is an image of an optimized return to home map 2300 superimposed over an original recorded return to home route 2910. The optimized return to home map 2300 demonstrates the dramatic reduction to memory requirements in safely navigating an environment with a reduced number of points of interest.

### Vocabulary

Operator (User)—a person operating an unmanned vehicle, for example, an unmanned aerial vehicle (UAV), an unmanned submarine drone, an unmanned aquatic drone, a terrestrial unmanned vehicle or terrestrial robot, and a subterranean unmanned vehicle.

HMD—head mounted display, e.g. VR, AR or stereo display headsets.

Telerobotics—the area of robotics concerned with the control of semi-autonomous robots from a distance [1].

Teleoperation—indicates operation of a system or machine at a distance [2].

Telepresence—refers to a set of technologies which allow a person to feel as if they were present, to give the appearance of being present, or to have an effect, via telerobotics, at a place other than their true location [3].

Human Machine Interface (HMI)—means by which humans and computers communicate with each other. The human-machine interface includes the hardware and software that is used to translate user (i.e., human) input into commands and to present results to the user [4].

Odometry—the use of data from motion sensors to estimate change in position over time. It is used in robotics by some legged or wheeled robots to estimate their position relative to a starting location [6].

Localization—the process of determining where a mobile robot is located with respect to its environment. Unlike odometry, localization output is the robot position in some absolute “world” coordinate frame, e.g. GPS or a map. Localization relies on odometry.

Real-Time Path Planning—consists of motion planning methods that can adapt to real time changes in the environment. This includes everything from primitive algorithms that stop a robot when it approaches an obstacle to more complex algorithms that continuously takes in information from the surroundings and creates a plan to avoid obstacles [19].

Bounding Box (BB)—a rectangle surrounding an object, that specifies its position (center of the rectangle) and its rough size. A bounding box can be 2D or 3D, for 2D image objects or objects in 3D space respectively. Bounding box is a standard output for various tracking and object detection algorithms.

On-Screen-Display (OSD)—a GUI overlay rendered upon the FPV camera video, containing the all the relevant real-time information for the drone operator.

Visual Odometry—odometry using input from camera sensors.

Visual Inertial Odometry (VIO)—odometry using input from camera, inertial sensors and gyroscope.

6 DoF Odometry—the odometry which computes all 6 degrees of freedom of a rigid body pose in 3D space, i.e. 3 rotation angles (pitch, roll, yaw) and 3 position coordinates (X, Y, Z).

First-Person View (FPV)—also known as remote-person view (RPV), or simply video piloting, is a method used to control a radio controlled vehicle from the driver or pilot's view point.

Tele-Augmented Reality (TAR)—basically, same as Augmented Reality [5], only from the drone's point of view using its FPV camera.

Robotics Perception (Perception)—geometric and semantic processing of the robot's surrounding environment, e.g. object detection and classification, depth estimation, semantic segmentation etc; usually using machine/deep learning techniques [10].

Registration—the process by which AR applications can obtain a reference spatial framework to place the virtual objects so that they match the expected location with respect to the real ones [18].

Simultaneous Localization And Mapping (SLAM)—the computational problem of constructing or updating a map of an unknown environment while simultaneously keeping track of an agent's location within it [20].

Micro-Tasks (MT)—the ARIADNE basic building block, a relatively simple task created by user in real-time and autonomously executed by the drone. ARIADNE teleoperation is basically a continuous execution of series of MT's, created one after another by the user in real time.

Path Planner—the functional component responsible for the path planning in the context of the given micro-task.

Line-Of-Sight/Non-Line-Of-Sight Tracking (LOS/NLOS)—line-of-sight tracking refers to optical tracking of an object or point, which must remain visible in the input video frames in order for the tracking to continue. Conversely, non-line-of-sight tracking supports cases when the object may be not visible during parts of the tracking process.

There are basically two widely implemented paradigms, when it comes to drone teleoperation: manual (real-time control by user of throttle and rotation angles, usually using control rods, i.e. sticks) and autonomous (setting GPS way-points, a target to follow etc.).

### 1.1.1. Manual Control

Pilots experience serious challenges for precise and safe drone operation when piloting vis manual stick control. These challenges are especially notable in obstacle-saturated environments (indoors, in urban settings, in dense vegetation, etc.). Obstacle-saturated environments require relatively long and intensive training. Even with training, such teleoperations are still highly prone to human error. These factors limit teleoperation piloted missions to a relatively small number of pilots with the necessary skills within a given organization (often a designated specialist) and expensive (both training and high rate of failure).

### 1.1.2. Autonomous Flight

Autonomous control, while much safer and easier for the operator, is severely limited in the number of its use cases. Building a fully autonomous system to operate in an arbitrary environment would represent a breakthrough in robotics due to the technological challenge of compensating for the infinite number of environment options the operating system would have to account for in flight. Even building AI robotic systems, which are designed to autonomously operate in a reasonably well-defined domain, e.g. self-driving cars, proved to be extremely difficult. Such specialized robotic systems have yet have been fully realized.

Therefore, while fully autonomous drones have an already inherently limited number of applications (e.g. security, inspection, delivery), the use cases are further limited by technological challenges, and in practice are confined to two main domains: open air (GPS-assisted waypoint navigation) or known indoor environment (pre-modeled or structured, e.g. warehouses and industrial facilities).

### 1.1.2. Conclusion

The confinement of virtually all the existing use-cases to these two narrow paradigms means, that there is a huge gap in the domain of all potential drone use-cases, especially in the indoor environment. ARIADNE is our attempt to fill this gap.

### 1.2. The Vision

The present disclosure presents the teleoperation paradigms not as two separate mutually exclusive alternatives, but as two extremes on a continuous spectrum of operation. An objective of the present disclosure is to bridge the two extremes and create a real-time drone teleoperation paradigm. In some embodiments, this paradigm may be described as a combination of two fundamental HMI aspects: highly immersive telepresence experience and extremely intuitive control via “task-and-fly” pilot assisted operations. Both aspects are mutually dependent, working together to achieve a synergistic effect as further discussed below.

### 1.2.1. Immersive Telepresence

In order for an operator or pilot to make timely and informed decisions, a highly immersive telepresence experience must be implemented. The telepresence experience simultaneously maximizes the operator's situational awareness, while reducing the stress and effort associated with using a telepresence device (e.g. screen, a VR headset etc). In some embodiments, it is a goal to maximize the operator experience of “being present” at the drone's location. Additional details is provided in the TAR section below.

### 1.2.2. Task-And-Fly

In some embodiments, an objective is to replace a task-and-fly operation, e.g., a task requiring intensive, continuous and error-prone pilot control, with discrete “micro-tasks” for an unmanned vehicle to accomplish autonomously. One non-limiting example of a task-and-fly operation is such as a mark-and-fly drone operation. Another non-limiting example is a fire-and-forget concept, applicable to drone-specific use cases. In each example, a series of micro-tasks shall or instructions, translate pilot-intent into simple common mobility and action use-cases. Non-limiting examples of instructions can include: a “go over there” instruction; an “approach this point/object” instruction; a “hover above this point/object” instruction; a “pick this object” instruction; a “place payload there” instruction; a “circle around this point/object” instruction; and a “follow this object.” In some embodiments an operator using a visual user interface, e.g., a virtual reality headset, marks a location within a field of view with a handheld joystick, and selects an object of interest. Based upon a known mission, the operator's intent may instruct an unmanned vehicle, like a drone to perform a number of micro-tasks. Exemplary micro-tasks might include implementing a “go over there” to the identified object and “hover above the object” before implementing an instruction to “pick up the object.” In the example, the pilot may simply mark the object of interest, and a policy associated with the mission could automatically transmit to the drone the necessary microservices to pick up the object of interest. Such a system reduces the amount of click instructions an operator may implement. This improves the situational awareness of the pilot and reduces the tedium of sending detailed instructions, especially when latency concerns limit the fidelity of received to broadcasted instructions. See further discussion below in High-Latency Teleoperation.

In some embodiments, when the situation requires more nuanced control, which is not covered by the available micro-tasks, the operator may “switch to manual”, i.e. mark-and-fly operation mode. However, the goal is for sequential execution of micro-tasks to be sufficient for a performing continuous and smooth flight mission. The micro-tasks are created using joystick or possibly voice commands. In some embodiments, the operator may elect to record the piloted motions for future use or store the instruction for further refinement after the mission is complete.

### 1.2.3. High-Latency Teleoperation

A large challenge with long-distance real-time teleoperation is the high latency between control input and the visual-auditory feedback back from the remote robot. With high enough latency any robotic system controlled via teleportation becomes unusable.

An objective of the present disclosure is to support teleoperation within the limitations of a reasonable latency (order of hundreds of milliseconds or even several seconds) in a relatively static environment since the micro-tasks are executed autonomously. The drone may then look up the ID, and cache the instructions for execution. In fact, in a perfectly static environment, an arbitrary latency can be tolerated in theory. Further analysis and tests are required to establish more concrete limiting parameters in various scenarios.

In some embodiments, the micro-tasks may be preloaded in a table of discrete tasks that are modified by sensed environmental information. For example, a drone ten meters off the ground may implement an approach command, compensating for the drone's determined present distance from an optimum height for retrieval of the object. In one embodiment, an ID number for the micro-task may be associated with the operator's intent and transmitted to the drone.

### 1.3. Getting There

The present disclosure is broken into several functional-technological components:
HW Platform—integration of various computation and sensors modules.
Perception—semantic and geometric “understanding” of the surrounding environment. Using AI find object, geometric structures (e.g.
planes) and provide their semantics (the type of the object or structure).
Navigation—localization and mapping. Find the drone location in a frame of reference or the constructed/provided map of the environment.
Tracking—locating points/objects of interests in the specified frame of reference.
Path Planning—autonomous flight within the given task to the target point/object.
TAR—augmentation of the visual data received from the drone sensors with synthetic data relevant to its teleoperation; target selection and task specification using the augmented visual data.
Algorithms—integration of all the above components into a concrete fully functional HMI use-case.

In some embodiments, the above components may be thought of as implemented in the order of implementation, and conversely in the reverse order of dependency—a component's implementation depends on at least one preceding component. For example, all the other components may depend on the availability of the appropriate computing and sensing hardware; tracking is based on perception (e.g., the need to detect an object to be able to track the object) and more advanced features may depend on navigation (tracking object in a reference frame may require knowledge of the drone's location in this frame) and so on.

As disclosed in U.S. provisional patent application Ser. No. 63/609,355, titled SYSTEM AND METHOD FOR DETERMINING A RETURN-TO-HOME MAP, filed on Dec. 13, 2023, the inter-component information flow is depicted in detail in FIG. 1.1—ARIADNE Meta-Algorithm. FIG. 1.1. depicts the information flow between the functional components.

The partition is conceptual, since every component is usually a set of loosely connected software components, which in practice may serve one or more purposes. For example, a 3D map of the drone's surrounding environment may be used for both Path Planning and Perception related functionality. In some embodiments, the principles outlined in the disclosure support operations in an indoor environment since this environment is suited to augmenting an operator's intent with micro-tasks and predefined instructions.

### 2. Perception

In some embodiments, perception may include geometric and semantic processing of the robot's surrounding environment, e.g. object detection and classification, depth estimation, semantic segmentation etc; usually using machine/deep learning techniques. Incorporation by reference is made to the Wikipedia article titled ‘Simultaneous Localization and Mapping,’ available at [https://en.wikipedia.org/wiki/Simultaneous_localization_and_mapping] as of Dec. 13, 2023, in its entirety. This article provides an overview of the principles and methodologies related to simultaneous localization and mapping (SLAM), including Extended Kalman Filter (EKF), Particle Filters, Monte Carlo Localization, Covariance Intersection, GraphSLAM, Bundle Adjustment, Maximum A Posteriori (MAP) Estimation, Set-Membership Techniques, Topological SLAM, Metric SLAM, Active SLAM, Multi-Agent SLAM, Acoustic SLAM, Audiovisual SLAM. The article further describes the core problem of simultaneous estimation of location and mapping, probabilistic modeling with Bayes' rule, landmark-based sensor models, raw data-based sensor models, dynamic environment handling, kinematics modeling with noise correction, loop closure for error correction, applications in autonomous systems and robotics, pre-mapped environments for simplified localization tasks, challenges in handling uncertainty and computational efficiency.

In some embodiments, a goal of Perception in the present context is for a robot to “understand” just enough about its environment, for the operator to create a new micro-task by relying on this understanding. An example is provided below.

Perception, Navigation and Path Planning may all include a geometric understanding of the drone's surrounding environment for their own goals-micro-task creation, localization and obstacle avoidance respectively. While it's possible for the same 3D information being shared for various task, in practice the technological solutions usually will be different, e.g., computing occupancy grid for Path Planning and sparse point cloud for Navigation (SLAM).

### 2.1. Passages

In some embodiments, the term “passages” may refer to any rectangular opening within an indoor environment connecting separate building compartments, e.g., doors, windows (of any kind), hallway entrances etc.

### 2.1.1. Purpose

Passages are some of the most challenging aspects of indoor navigation, basically “chock points” of the robot configuration space (roughly, all possible robot positions in 3D space). In practice this means several things:
1. They may improve the ability to pass through to navigate indoors.
2. They are relatively frequently navigated areas of space during indoor space exploration.
3. They are relatively well-defined objects.
4. Their relatively small size means a special challenge for manual (even mark-and-fly) control.

The combination of all the factors above means, that automating navigation through passages is likely to simplify the indoor flight control.

### 2.1.2. Passage Detection 2D

Functionality:
Computes 2D bounding boxes in the input image.
Allows simple autonomous drone navigation to the passage via center tracking.
No 3D position and orientation of passage-no path planning.

### Prerequisites:

Prerequisites are provided for illustrative purposes. While specific hardware is disclosed, a variety of hardware solutions may be used to realize the benefits of the feature implementation. For example, while a camera is disclosed, a LiDAR solution might similarly be used to record an environment. Similarly, while Jetson is a suitable mobile computing system capable of real-time deep learning processing, suitable alternatives may be selected to achieve processing speed requirements, battery life requirements, and weight requitements as a few examples.
Can be implemented using only the monocular FPV camera.
Requires Jetson for object detection and tracking (using deep learning).

### 2.1.3. Passage Detection 3D

Functionality:
Computes the set of four 3D points—the passage corners.
Allows autonomous optimal 3D path planning to the passage.

### Prerequisites:

A stereo camera.
Jetson.

### 2.2. Planar Surfaces

### 2.2.1. Purpose

An integral part of virtually all micro-tasks creation is a target designation. In some embodiments an operator may want to mark for the drone either an arbitrary point in 3D space or a discrete object. Marking an arbitrary point in 3D space requires orienting/placing the virtual marker in relation to the visible indoor surfaces. The planar surfaces are of especial importance for the following reasons:
1. Planar surfaces, such as walls, floors, and ceilings, dominate indoor geometry and virtually always present in field of view.
2. Even without stereoscopic display, planar surfaces provide rich and intuitive visual cues about other objects' size and distance.
3. Can be used for identifying and designating potential landing spots.
4. Some planar surfaces may be used for orientation, for example floors are often used for path visualization.
5. Photogrammetry—3D reconstruction & mapping of the drone environment. Planar surfaces can potentially have an advantage over the regular SFM methods, which are fragile, noisy and computationally expensive. Approximating the environment with planes results in a less detailed representation of reality, but much more robust, geometrically consistent and visually clear reconstruction (as opposed to dense point clouds, for example) [22].

### 2.2.2. Method

In some embodiments, there are at least two broad methodologies to solve this challenge:

Using deep learning [21]:
a) can be computed using a monocular camera
b) requires Jetson/AI accelerator for inference
c) potentially noisy/unreliable output; relative robustness w.r.t. untextured surfaces. For additional context regarding deep learning, reference is made to the YouTube video titled ‘[CVPR19] PlaneRCNN: 3D Plane Detection and Reconstruction from a Single Image,’ available at https://www.youtube.com/watch?v=d9XfMvVXGwM, which demonstrates aspects of a neural architecture PlaneRCNN. The content of this video is incorporated by reference in its entirety for its description of 3D model visualization, outdoor scene visualization, ablation study, and new view synthesis.

Classic methods using stereopsis, depth maps or laser scans (see for example):
a) requires at least a stereo-camera; but also may require, depending on the used algorithm, a depth camera or LiDAR
b) relatively geometrically accurate output; poor handling of untextured surfaces, especially when relying purely on stereo

Both methodologies have their respective advantages and disadvantages, which will be explored during the development. A chosen direction may also depend on respective TAR functionality—for example, if a target point designation only requires floor (“teleportation”), which are typically relatively textured surfaces, simple and cheap perhaps stereo-related methods may be preferred.

### 2.3. Drones

Detect and track other drones for swarm related use-cases.

### 3. Navigation

In some embodiments, robotics navigation can include self-localization, path planning, and mapping (for self-localization). In the present disclosure, the navigation component will only include localization-related functionality, and the path planning component will be discussed in a separate section below. In some embodiments, a goal of navigation may be to localize the robot in a coordinate frame or a map, where the map can be either predefined or constructed by the robot during its navigation (SLAM).

Odometry is the use of data from motion sensors to estimate changes in position over time [6]. In some embodiments, a method to estimate the position of the drone relative to some starting position (e.g., the take-off point) is to integrate the drone's velocity constantly computed from the drone's sensors, i.e., IMU and cameras. Odometry is the basic building block of any localization algorithm.

### 3.1. 2D Odometry

3.1.1. An exemplary purpose

Using a downward facing camera and IMU the drone odometry is computed in the horizontal plane. This is used to stabilize drone in flight (e.g., in lateral axis during straight forward flight) and during position-hold (drone staying in a determined position); it is also can be used for a rough estimation of flight path in 2D.

In the context of the present disclosure, 2D odometry can only support features which do not require full 6DoF position of the drone: basically, simple line-of sight tracking features without obstacle avoidance or any other path planning related functionality.

### 3.1.2. HW Prerequisites

2D odometry is a relatively computationally inexpensive functionality and can be implemented using Raspberry Pi 4 or similar hardware.

### 3.2. Full 6DoF Odometry

### 3.2.1. Purpose

6DoF (Degrees of Freedom) describe the full rigid body pose in 3D space—3 position coordinates+3 orientation angles. 6DoF odometry is the integral component of full robot localization functionality.

In the context of ARIADNE, 6DoF odometry allows more robust and sophisticated tracking of the points and objects. For example, non-line-of sighttracking of an object. That is, if an object initial 3D position was provided out of the drone's tracking camera field of view, or disappeared from the field of view during the tracking, it would be possible for drone to find the object by tracking the drone's own 3D pose relative to it. It will also allow more complex path planning towards the target object, which will not require the target object to remain in the tracking camera field of view.

### 3.2.2. HW Prerequisites

The minimum computational power required for 6DoF odometry algorithms can be provided by either Jetson or RB5 platforms. Jetson Xavier platforms are also providing their own SW localization solutions and are probably the most realistic option for our purposes.

There are several sensor configurations (monocular camera+IMU, stereo, stereo+IMU etc.), which can support a 6DoF odometry computation. For our purposes, a minimum of stereo cameras with a good IMU is a realistic minimum for a robust solution.

### 3.3. Local Map Localization

### 3.3.1. Purpose

Construction of a map (usually occupancy grid) of the drone's immediate surrounding environment in the receding horizon fashion and computing the drone 6DoF pose in this map. This is required for path planning (obstacle avoidance) during autonomous execution of the micro-tasks in a congested/obstacles-saturated environment.

### 3.3.2. HW Prerequisites

Same as for 6DoF odometry.

### 3.4. SLAM

### 3.4.1. Purpose

Constructing or updating a map of an unknown environment while simultaneously keeping track of the drone's location within it [20]. In the context of the system, accurate and robust SLAM will allow marking an object location in a global frame of reference, allowing other agents (drones, people) sharing this map to navigate towards the marked object. Map sharing, it should be noted, is a non-trivial problem by itself, which is usually not solved in the context of a typical SLAM system.

Generally, SLAM is required for a typical autonomous flight tasks, e.g. automatically returning to the take-off point.

### 3.4.2. HW Prerequisites

At the very minimum, same as for 6DoF odometry. Possible implementation will include a distributed execution over several HW components, e.g., on drone on-board computer and/or a ground station such as a Ground Control Station. A robust solution, capable of handling wide range of challenging environments, will most probably require use of LiDAR.

### 4. Tracking

For the purpose of this document, tracking is responsible for computing a given object's location in the specified frame of reference, e.g., in 2D image reference frame, 3D drone's body frame, an arbitrary 3D physical world frame etc. The object location is required for TAR and path planning.

In case of TAR, tracking output will be computed, for example, in a stereo FPV camera reference frame. This will allow TAR to render synthetic augmentation items (e.g. an arrow pointing to the object), whose pose will be visually consistent with the tracked object.

In case of path planning, the tracking is responsible for providing the target objects' location in a context of the given micro-task. The path planer then will plan the drone trajectory to the tracked object. From implementation point of view, in some cases the distinction between perception and tracking can be arbitrary-if a particular perception functionality includes object localization in the FPV camera coordinate system, then it de-facto provides tracking functionality. However, there are an important technological and algorithmic differences between perception and tracking, which will require separate research and development efforts: perception functionality is developed using AI techniques (primarily Deep Learning), while tracking will mostly rely on classic CV methods (feature extraction and matching, stercopsis, Structure-From-Motion etc). All the features below build upon perception, therefore the basic prerequisites for them all are going to be the same as for the relevant perception functionality.

### 4.1. 2D Image Frame

The detected object is tracked in the input camera image 2D reference frame. This allows line-of-sight target tracking-basically, relatively simple path planning towards the target object, such that it stays in the center of the tracking camera. This is often the simplest configuration, but also very limited in its usefulness, type of tracking. No estimation of distance to the object, its size and orientation (only possible in special cases with their own limitations) poses serious challenges for even the simple path planning—e.g. the path planner doesn't know when to stop the drone.

### 4.2. 3D Body Frame

### 4.2.1. Overview

The 3D body frame tracks the object pose (position and orientation) in the drone body reference frame. Leaving aside for the moment particulars of camera configuration and calibration, this allows us to know the position of the object in the FPV camera reference frame. This, in turn, will allow us to render virtual 3D augmentation items perceptually consistent with the 3D geometry of the scene. This functionality enhances an AR experience in any VR/Stereo display, where the scene is perceived in 3D by the user. It can also greatly assist in a regular 2D display (screen or HMD), since even in 2D correctly rendered 3D items will provide powerful visual cues regarding geometry, distance and spatial relationships between objects. It also solves the problem of estimating the object distance and its orientation, which allow a more sophisticated path planning with optimal direction and speed estimations as the drone approaches the target.

### 4.2.2. Physical Points & Objects

Track arbitrary physical points (i.e. points on actual physical surfaces) and objects marked by user—for navigation and interaction (e.g. picking). If the objects to be detected are of known predetermined types, this becomes a more general problem of passage detection.

### 4.2.3. Virtual Points

Track a virtual (as opposed to physical) point in 3D space, i.e. points in air, which are not necessarily part of a physical object. This is to allow fluid continuous navigation from-point-to-point (VR “teleportation”) or just easily placing drone at any point in space without manual control. This feature heavily relies on planar surfaces detection, since a virtual point can be only defined by user in relation to the visible surrounding environment. The point can be tracked either by tracking the related physical points or via tracking the drone position (odometry/localization), or a combination thereof.

### 4.2.4. Prerequisites

Object detection perception functionality and related hardware.
Stereo/depth camera for stereopsis.
Planar detection for the virtual points.

### 4.3. Local Map

### 4.3.1. Purpose

Same as 3D Body Frame tracking, with an added benefit of the knowledge of the surrounding environment geometry. This knowledge allows no line-of-sight tracking. Meaning, since the target is being tracked in the local map reference frame, even when it disappears from the tracking camera field of view, the path planner will be still able to navigate drone towards the target.

Moreover, in case of TAR, it will be possible to visually designate the target outside of the FPV image, e.g. in the virtual representation of the local map or by providing visual cues about the direction of the target outside of the field of vision-more about this in the TAR section below.

### 4.3.2. Prerequisites

Same as for the 3D Body Frame tracking, plus Local Map functionality for navigation.

### 4.4. 3D World Frame

### 4.4.1. Purpose

Basically, Local Map tracking on steroids-more robust and with tracked targets being as far as the global map allows. This allows points of interests sharing between more several drones, other multi-drone collaborative tasks.

### 4.4.2. Prerequisites

Same as for the 3D Body Frame tracking, plus full SLAM functionality for navigation.

### 5. Path Planning

### 5.1. 2D Target Tracking

### 5.1.1. Purpose

This is the simplest case, where the target is supplied as 2D point (and/or the object bounding box) in the tracking/FPV camera image coordinates for every frame received from camera. The path planner steers the drone s.t. the tracked object stays in the middle of the input image. As for now, this type of path planning is intended only for the simplest 2D case of the passage tracking.

### 5.1.2. Limitations

There is no way to estimate the distance to the target, except in some special cases, under very strict assumptions, which makes it impractical. In case of the passage tracking, it means the drone doesn't “know” when to stop. This happens, when the passage is so close to the drone, the door or window frame used for tracking is not visible anymore, and therefore cannot be tracked.

### 5.2. 3D Target Tracking

### 5.2.1. Purpose

In this case, the target's 3D pose is provided in the drone's reference frame for every video frame received from the tracking stereo camera. Unlike in the 2D case, now the distance and the orientation of the target are known. So the path planner can steer the drone at optimal speed and direction relative to the target. For example, a passage can be approached from the orthogonal direction to maximize the clearance, and the drone will be able to slow down/stop at the appropriate distance from it. The partial obstacle avoidance functionality can be achieved with planar surfaces detection discussed in 2.2.

### 5.2.2. Limitations

In the absence of the knowledge of the surrounding geometry, full trajectory generation with obstacle avoidance is impossible.

### 5.3. Trajectory Generation in 3D Local Map

### 5.3.1. Purpose

Here the the path planner has an access to a 3D local map-basically, the 3D geometry of the drone's surrounding environment. The input to the path planner is the map itself and the target pose in the map's reference frame. This allows an optimal trajectory generation with obstacle avoidance.

### 5.3.2. Limitations

Local maps are usually constructed using occupancy grid or similar volumetric representations of the 3D geometry. The quality of the path planning in this case extremely depends on the quality/robustness of the map, its completeness and resolution. A low resolution map, for example, can prevent from drone to fly through gaps, which are wide enough in reality.

Given the technological challenges required to implement local map functionality, its added value is not obviously justifiable.

### 5.4. Fully Autonomous Flight

### 5.1.1. Purpose

This is by far the most challenging path planning functionality, requiring robust SLAM solution. The functionality allows fully autonomous drone navigation from one arbitrary point to another in a global map of a complex indoor environment (e.g. a multi-room building). This may be required for any use-cases involving target sharing.

As with the Local Map functionality, the added value of fully autonomous flight in the present disclosure varies.

### 5.1.2. Limitations

Very serious technological challenges, required HW cost and integration.

### 6. TAR

This section deals with video display and synthetic data visualization in the context of the system. This is referred henceforth as TAR-Tele-AR (Remote Augmented Reality). The basic idea behind TAR is creating a highly immersive experience of being present in a remote environment (telepresence)—via drone and its sensors, with synthetic augmentation of the visual data from video streaming from the drone's cameras. Where the synthetic augmentation of the scene is to facilitate the system specific functionality.

The terms synthetic and virtual are used mostly interchangeably, while synthetic is meant as a more general description for any visual artifact rendered onto the input video of the physical scene, and virtual is meant to differentiate between an actual physical object and its synthetic representation.

Another key term extensively used in this section is registration, defined in the Vocabulary section as following:
the process by which AR applications can obtain a reference spatial framework to place the virtual objects so that they match the expected location with respect to the real ones

In other words, registration is about rendering virtual/synthetic items onto the input video in such a way, so their pose is consistent with the corresponding physical objects. For instance, a virtual text box annotating a physical object will appear to be connected to the physical object and placed at the appropriate distance; as object moves, the box moves accordingly. Strictly speaking, unregistered synthetic overlay normally would not be considered an AR functionality. Still, we start here from describing the unregistered cases, since they are first logical steps to more complex “true” AR.

### 6.1. 2D Unregistered

Basically, the “regular” FPV drone OSD (On Screen Display). Here the 2D synthetic items are rendered usually at fixed positions onto the FPV video.

### 6.2. 3D Unregistered

Here the input video is either stereo or mono displayed in a stereoscopic HMD (one separate optic channel per eye). The synthetic items are rendered in 3D-basically, each eye sees a synthetic item rendered at different angle and horizontal offset from the center of the image, thus creating 3D appearance through stereopsis. Note, in case of the input video from a monocular FPV camera, the same video stream is shown in both optic channels, but the overall effect remains the same.

Even if the rendered item is geometrically two-dimensional, e.g. a text notification, it is still possible to create a 3D-like effect by rendering the text at different offsets in both optical channels—in this case the text will appear “hovering” between the user and the physical scene. Conversely, rendering items, 3D or 2D, without any offset onto an input stereo video will create potentially confusing and even unpleasant effect-since the item will simultaneously appear at infinity and in front of physical objects.

This functionality, while being technologically relatively simple, can provide a relatively large added value, by giving user much richer and more engaging visual experience-see FIG. 6.1 for an example of kind of futuristic UI is possible to create. This can be also a very good test case for more advanced registered functionality.

In some embodiments, while all items may be rendered in 3D, two particular UI elements will especially benefit from being rendered in 3D—the attitude indicator (gyro horizon) and compass. Those UI elements indicate the orientation in the physical world, and being rendered in 3D will provide much more intuitive picture of reality. As disclosed in U.S. provisional patent application Ser. No. 63/609,355, titled SYSTEM AND METHOD FOR DETERMINING A RETURN-TO-HOME MAP, filed on Dec. 13, 2023, an exemplary user interface demonstrating the principles is depicted.

### 6.3.2D

In some embodiments, the input is a video from monocular FPV camera. The synthetic items may be 2D elements, whose 2D size and position are aligned with the physical object. For example, the tracked passages are marked with 2D bounding boxes. As disclosed in U.S. provisional patent application Ser. No. 63/609,355, titled SYSTEM AND METHOD FOR DETERMINING A RETURN-TO-HOME MAP, filed on Dec. 13, 2023, an example of marked tracked passages using 2D bounding boxes is depicted.

### 6.4. 3D Registered in Body Frame

In some embodiments, the body frame is the drone (body) frame of reference. For all intents and purposes body frame and the FPV camera frame are basically the same.

In this case 3D position of a point of interest or full pose of a 3D object is computed in real-time. Technically, the displayed video can be mono or stereo—in both cases the virtual 3D object or other synthetic augmentation can be rendered in such a way as to appear visually aligned with the physical object. An example would be a 3D rectangle rendered onto a tracked passage entrance, a trajectory computed towards the passage, and an annotation with passage ID and other information (please see the illustrations in the section 8. Technological Components).

In some embodiments it is possible to create synthetic stereoscopic registered overlay without explicitly computing 3D geometry of the augmented object. In this case stereopsis (human 3D perception) of the synthetic overlay is achieved implicitly by rendering 2D registered synthetic items independently in each optical channel.

In some embodiments, synthetic UI elements relevant to the system may include at least the following:
1. Planar Surfaces Indicators-Indicates the planar surfaces for interaction.
2. Target Indicator-A tracked target point or object in the current micro-task.
3. Passage Indicator-Indicates the detected passages.
4. Pointers-Virtual rays/arcs for marking target points/objects.
5. Trajectory Indicators-Shows the virtual trajectory for the current micro-task.
6. Annotations-Textual information elements attached to physical or virtual objects.

Please see Section 8.0 for exemplary UI elements illustrations in the context of the respective use-cases.

### 6.5. 3D Registered in Local/Global Map

In some embodiments there may be access to the 3D map of drone's surrounding environment or a global map (e.g. obtained from SLAM). In such instances the target poses in the map's frame of reference are known. In addition to the to the body frame registered functionality, this allows to display the indicators of the targets (passages, points, objects), which are not in the field of view or are obstructed by other physical objects. This can be done in two basic ways:
1. Display the synthetic indicator elements in the field of view, s.t. they point in the correct direction to the corresponding physical target, which is invisible at the moment.
2. Display the local map as another UI element with the target indicator inside the map. See FIG. 6.3 for an example of how this might look like. Note, in this image the drone itself is shown in the map, but this could be any other tracked target.

### 6.5. VR vs Stereo HMD for TAR

In both cases the use of a video from the drone's FPV stereo-camera to observe the physical reality, adding a synthetic overlay of registered and unregistered elements. The crucial difference between VR and a stereo HMD is head tracking.

Head tracking allows head movement in a kind of virtual cockpit, which may be defined by various UI elements one of which is the actual video from the drone's FPV stereo-camera. FIG. 6.3.

shows a screenshot from such VR demo (note, how in this screenshot the head is slightly turned to the left). The benefit of the approach is the ability to add various UI elements outside of the input video, thus effectively enlarging our visual space. Potential disadvantage is a less immersive experience—by disassociating the gaze direction with the actual drone's direction.

Another possibility is synchronizing user head movements with FPV camera orientation, or using a panoramic video—for now we leave these ideas out of the scope of the road-map.

In the context of the system's road-map we are focusing on the regular stereo HMD, while VR is left as a potential direction for further exploration. As disclosed in U.S. provisional patent application Ser. No. 63/609,355, titled SYSTEM AND METHOD FOR DETERMINING A RETURN-TO-HOME MAP, filed on Dec. 13, 2023, an example of VR demo of a 3D map (point cloud) of an exemplary drone surrounding environment with the drone's 3D position and pose is depicted in FIG. 6.3.

### 7.0 Hardware

the system related hardware can be partitioned into the following categories:
general purpose embedded platform, e.g. Raspberry Pi and Jetson—for computer vision, state estimation, image processing, odometry, mapping, graphics (GUI, AR) etc.
dedicated AI processors, e.g. Coral [7] and Hailo [8]—for perception-related NN inference, e.g. object detection
camera and LiDAR sensors—for FPV, odometry, mapping, perception
displays, e.g. screen, AR/VR/stereo HMD's—for TAR

As disclosed in U.S. provisional patent application Ser. No. 63/609,355, titled SYSTEM AND METHOD FOR DETERMINING A RETURN-TO-HOME MAP, filed on Dec. 13, 2023, an example of VR demo of a 3D map (point cloud) of a possible hardware software configuration for the system is depicted in FIG. 2.1. The HW components may either be used in the ground control station (GCS) or on the drone itself (ground vs airborne). While in principle some components can be implemented either on the ground or airborne HW (e.g., object detection can be computed on the airborne or ground computer), for the purpose of the road-map outlined below the assignment is as follows:
Drone: Navigation, Perception, Path Planning. Ground: Tracking, TAR.
Below is the tentative development and integration road-map of the hardware components, their respective purposes and limitations.

### 7.1 Raspberry Pi 4 (Drone)

### Purpose

In an exemplary embodiment, an onboard computer may be used for optical flow based 2D odometry computations.

### Limitations

Limited to two cameras, highly unlikely to run anything more performance demanding than a single instance of 2D odometry (possibly, not tested, two instances), e.g. anything requiring real-time stereo or deep learning.

### 7.2 Jetson Xavier NX (Drone)

### 7.2.1 Purpose

Allows real-time image processing necessary for real-time stereo computing, 6 DoF odometry and real-time neural net computation for perception functionality.

### 7.2.2 Limitations

Depending on the algorithm used, the working assumption is that every component assigned for the Drone computer (either Perception, Navigation or Path Planning) will more or less fully exhaust its computation resources.
Stereo/Depth Camera.
FPV human 3D perception of the scene and UI elements.
A bare minimum for 6 DoF visual odometry (there are VIO methods which allow to compute 6 DoF odometry from combining IMU and a monocular camera, but are less robust and are much harder for integration and calibration).
Points/objects 3D position computation in the drone reference frame; necessary for 3D mapping, path planning, tracking etc. Perception vs FPV camera-same/separate. Pros/cons and prerequisites for both configurations. Graphical illustration.
Disadvantages of the depth camera.

### 7.4 Dedicated AI Processor

### 7.4.1 Purpose

HW specifically designed to run neural net computations at relatively high frame rate and with relatively low power consumption.
Allows us to offload these tasks from Jetson (or other drone or ground computer). For instance, a Hailo AI Processor [8] may potentially allow to run most, if not all, of perception functionality, thus freeing onboard Jetson for Navigation.

### 7.4.2 Limitations

Possible compatibility issues between various AI accelerators and embedded platforms (Jetson).

Neural nets most probably will have to be modified/adapted to run on an accelerator (partial support compared to Jetson).

### 7.5 360° Navigation Sensor Array

### 7.5.1 Purpose

Provide spherical (full or partial) camera coverage of the drone's surrounding environment. Necessary for construction of local 3D map of the drone's surrounding environment at any frame.
Allows obstacle avoidance in any direction of the drone movement—as opposed to the forward flight with one stereo sensor. (Technically, it's possible to construct 3D map from one forward stereo sensor, but this is much more algorithmically and computationally challenging, and less robust.)

### 7.5.2 Limitations

Requires extremely challenging mechatronics development and integration, e.g. custom electronic components. Requires special HW supporting simultaneous multiple video streams processing.
Relatively complicated calibration process-during development, production, and possibly by customer. Realistically, will require usage of specialized platform (e.g. RB5 [12]).

### 7.6 LiDAR

### Purpose

High accuracy 3D scanning of the drone's surrounding environment.
Realistically, the only sensor which will allow full robust SLAM functionality (for example please see [13] and [14]).

### Limitations

Weight.
Cost.
Energy consumption.

### 8.0 Teleoperation Method and Use-Cases

This section assembles functional-technological components into use-cases. As in previous sections, these use cases are listed in the order of their logical progression and represent the system. As disclosed in U.S. provisional patent application Ser. No. 63/609,355, titled SYSTEM AND METHOD FOR DETERMINING A RETURN-TO-HOME MAP, filed on Dec. 13, 2023, an example of the prerequisites is summarized in FIG. 8.6.

### 8.1 Mark & Fly

While the existing Mark & Fly functionality technically is not required by the system, it nevertheless represents a first logical step towards the system vision—the first step beyond fully manual stick control and towards fully autonomous micro-task instruction execution.

A possible extension of this feature, which would make it fit within the scope of the system vision, would be automatic linear path planning towards an arbitrary point marked and tracked in 2D.

### 8.2 Mark Passage & Fly

As explained above, passages represent a case of special interest because of their both significance and difficulty for indoor flight (please see section 2.1.1 of the present disclosure for detailed motivation). In some embodiments, it is an objective for a drone to automatically detect and track all the passages in its field of view. Then, the user shall select the target passage and the drone will autonomously pass through it.

### 8.2.1 2D Case

The passage detection and tracking can be accomplished with one or more 2D input images from a 2D FPV camera, an example of which is included in FIG. 6.2 of U.S. provisional patent application Ser. No. 63/609,355, titled SYSTEM AND METHOD FOR DETERMINING A RETURN-TO-HOME MAP, filed on Dec. 13, 2023. The TAR experience may designate the target passage using rectangle overlays in the FPV video.

A limitation of the 2D tracking is the inability of the path planner to detect the size, orientation, and, most crucially, the distance of the target passage. This means the path planner cannot compute the optimal direction and speed of approach to the target passage. There is a way to estimate both distance and orientation very roughly and this is ongoing POC for the time of writing this document.

### 8.2.2—3D Case

The passage is tracked in the stereo camera, so the full 3D geometry of the passage (distance, size, orientation) is known.

This allows rendering 2.5D/3D virtual overlay in stereo/VR HMD so that it will be correctly registered to the physical passage—basically, a virtual 3D item representing the target passage (an arrow pointing to it, passage frame, etc.) will appear to the user correctly embedded in the physical scene.

The path planner will be able to plan the flight trajectory in an optimal way—for example, the drone will approach the passage in a direction orthogonal to the passage plane (to maximize the clearance), change the velocity depending on proximity to it and finally stop after the passage is entered. See the image sequence of FIG. 8.1 of U.S. provisional patent application Ser. No. 63/609,355, titled SYSTEM AND METHOD FOR DETERMINING A RETURN-TO-HOME MAP, filed on Dec. 13, 2023.

### 8.3 Mark 3D Target & Fly

### 8.3.1 Physical Target

In some embodiments, the physical target may refer to a point on surface or an object—as opposed to a virtual target, which can be an arbitrary point in 3D space around the drone. Whether we mark and use an arbitrary point or an actual object depends on a specific micro-task (see below), where the objects will usually belong to a predefined set of classes, e.g., people, guns, etc.

The point is selected using a remote control—for example, in a fashion similar to the Oculus virtual laser pointer. TAR provides virtual augmentation of the selected point or object—tracking marker and relevant annotation.

The possible corresponding micro-tasks: Approach

In one scenario, a drone flies towards the specified target and hovers in front or above it (FIG. 8.2). The choice of the hovering position relative to the target may depend on its position (e.g., horizontal plane—above, walls—in front of), particular drone configuration (FPV camera placement on the drone and its degrees of freedom), or specified through UI.

Follow (an object)—The drone follows the target object—e.g., a person (for example, FIG. 8.3 of U.S. provisional patent application Ser. No. 63/609,355, titled SYSTEM AND METHOD FOR DETERMINING A RETURN-TO-HOME MAP, filed on Dec. 13, 2023). FIG. 8.3 details a scan for either a point or an object. In the image sequence, the drone approaches the designated target and flies around it in a predefined trajectory, while keeping it in focus. Pick (an object) The drone approaches the designated target and a) automatically picks it (can be extremely technologically challenging), or b) is manually operated to complete the task (which is a private case of the Approach micro-task).

### 8.3.2 Virtual Target

As mentioned above, a virtual target can be any point in the visible 3D space around the drone. We envision the micro-tasks using a virtual target to be the core of the ARIADNE functionality, since they allow free navigation in indoor environment and can potentially (almost) completely replace the fully manual control.

An advantage of marking a virtual target is to use the surrounding 3D geometry as a reference, relative to which the virtual target is defined. In some embodiments, the focus may be on using planar surfaces for reasons explained in section 2.2.1, the most important of which is the fact that planar surfaces (especially walls and floor) provide powerful visual cues for scene objects size and their relative distances. Thus, using an arbitrary nondescript point on a wall or floor as a reference to a virtual target near it, will give a user an intuitive grasp of the target position.

In some embodiments, only the Approach micro-task is relevant for the virtual target. TAR can visualize the synthetic artifacts for marked reference points, the arc/ray pointer used to mark the point, and the reference axes connecting the virtual point to the reference, etc.

In some embodiments, one or more of the following may be used for marking a virtual point:

Floor/Wall Reference with Current Height/Clearance (See FIGS. 8.4 and 8.5 of U.S. provisional patent application Ser. No. 63/609,355, titled SYSTEM AND METHOD FOR DETERMINING A RETURN-TO-HOME MAP, filed on Dec. 13, 2023). FIG. 8.4 demonstrates the use and arc pointer to mark a reference point. The virtual target is created at the drone's current height/clearance. Floor/Wall Reference with Specified Height/Clearance. Use ray or arc pointer to mark a reference point, extrude this point vertically from the floor or horizontally from the wall to an actual target point. 8.4 Collaboration & Autonomy

Collaboration & Autonomy may refer to fully autonomous tasks and multi-drone collaboration. These two functionalities may have a large overlap between them and the core functionality required for their implementation in any non-trivial indoor environment (i.e. more than just one room) is full SLAM and global map path planning.

Collaborative tasks are based on, or can be built from, the previously mentioned micro-tasks. Only this time, a micro-task can be executed by one drone using a target marked by another drone. The basic micro-task flow might be accomplished as following:
1. 1. Drone A marks a target (virtual or physical). 2. Drone A shares the target description (position, visual signature, type etc.) in the global map's reference frame. 3. Drone B autonomously navigates to the target and executes a specified micro-task.

Note, strictly speaking, autonomous path planning and navigation are not required—user can navigate “manually” (using micro-tasks) to the marked object, using the visualized global map for reference.

### 8.5 Putting It All Together

### 8.5.1 3D Display in ARIADNE's Context

All the use-cases above do not inherently necessitate usage of the 3D displays—all the 3D UI elements can be rendered on 2D display just as well. However, we do strongly believe that in order to achieve the synergistic effect, as we mentioned earlier in the 1. Introduction section, a 3D HMD is an absolute must.

The human visual perception is fundamentally three dimensional, although it's limited to relatively short distances of several meters. To effectively designate the micro-task targets, especially the virtual ones, we need a very good intuitive grasp of 3D geometry around the drone. And the best way to achieve this is using human stereopsis-via stereoscopic video display.

### 8.5.2 Control Flow

In some embodiments, a goal is to create a fluid control experience, where micro-tasks are seamlessly concatenated into one continuous flight.

Such a flight could look something like this:
mark window and fly in
rotate; find a direction for the exploration
mark object on the table and approach from above
mark door and fly in
rotate; find a direction for exploration
mark virtual target and fly; while flying find objects of interest or new directions for exploration

Note, the “manual” rotation of the drone upon completion of a micro-task could be part of the micro-task somchow—for now we'll leave for future consideration.

### REFERENCES

1. https://en.wikipedia.org/wiki/Telerobotics
2. https://en.wikipedia.org/wiki/Teleoperation
3. https://en.wikipedia.org/wiki/Telepresence
4. https://www.britannica.com/technology/human-machine-interface
5. https://en.wikipedia.org/wiki/Augmented_reality
6. https://en.wikipedia.org/wiki/Odometry
7. https://coral.ai/
8. https://hailo.ai/
9. https://en.wikipedia.org/wiki/First-person_view_(radio_control)
10. https://www.esa.int/Enabling_Support/Space_Engineering_Technology/Automation_and_Robotics/Robotics_P erception
11. https://en.wikipedia.org/wiki/Simultaneous_localization_and_mapping
12. https://www.qualcomm.com/products/robotics-rb5-platform
13. https://www.livoxtech.com/mid-70
14. https://ouster.com/products/scanning-lidar/os0-sensor/
15. https://www.microsoft.com/en-us/hololens
16. https://www.oculus.com/quest-2/
17. https://www.fatshark.com/product-category/headsets/
18. https://www.igi-global.com/dictionary/3d-registration/65429
19. https://en.wikipedia.org/wiki/Real-time_path_planning
20. https://en.wikipedia.org/wiki/Simultaneous_localization_and_mapping
21. https://www.youtube.com/watch?v=d9XfMvVXGwM
22. Stamos, Ioannis & Yu, Gene & Wolberg, George & Zokai, Siavash. (2006). 3D Modeling Using Planar Segments and Mesh Elements. 3DPVT 2006.
23. https://en.wikipedia.org/wiki/Robot_navigation
24. Isaac ROS Visual Odometry
25. Unity-ROS Interoperability Study

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure and may be included in more than one embodiment of the present disclosure. Importantly, such phrases do not necessarily refer to the same embodiment.

While embodiments of the system have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within the context of this document terms “coupled to” and “coupled with” are also used euphemistically to mean “communicatively coupled with” over a network, where two or more devices are able to exchange data with each other over the network, possibly via one or more intermediary device.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

While the foregoing describes various embodiments of the disclosure, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

What we claim is:

1. A system for lossy optimization of a return-to-home route, the system comprising:
a. a non-volatile memory;
b. a wireless transceiver;
c. a processor in communication with a non-volatile memory comprising a processor-readable media having thereon a set of executable instructions, configured, when executed, to cause the processor to:
i. receive via the wireless transceiver of coordinate samples (kₙ) over a time interval, wherein each coordinate sample comprises at least two dimensional pairs (x,y) and a vehicle yaw, the two-dimensional pairs (x,y) indicative of a pilot-assisted vehicle path over the time interval;
ii. identify a first coordinate pair of interest (x₀,y₀) and yaw₀, a subsequent second coordinate pair (x₁,y₁), and a third subsequent coordinate pair (x₂,y₂) and yaw₂;
iii. calculate a first vector of interest V1 from the first coordinate pair of interest (x₀,y₀) and the subsequent second coordinate pair (x₁,y₁);
iv. calculate a candidate vector of interest V2 from the subsequent second coordinate pair (x₁,y₁) and the third subsequent coordinate pair (x₂,y₂);
v. calculate an angle of congruence α between the first vector of interest and the candidate vector of interest V2;
vi. determine whether the angle of congruence α is indicative of a large angle change;
1. discard the subsequent second coordinate pair (x₁,y₁);
2. discard the third subsequent coordinate pair (x₂,y₂) if the angle of congruence α is not indicative of the large angle change and storing the first coordinate pair of interest (x₀,y₀) as a last coordinate sample of interest and yaw₀ as a last yaw of interest in the non-volatile memory; or
3. storing change in the non-volatile memory the third subsequent coordinate pair (x₂,y₂) as a last coordinate sample of interest and yaw₂ as a last yaw of interest if the angle of congruence α is indicative of the large angle; and
vii. compare the last yaw of interest to a subsequent yawₙ associated with a subsequent coordinate pair of interest (xₙ,yₙ) to determine whether a yaw condition is met; and
1. discard the subsequent coordinate pair of interest (xₙ,yₙ) and subsequent yawₙ if the condition is not met and retrieve a subsequent yawₙ₊₁ associated with a subsequent coordinate pair of interest (xₙ₊₁,yₙ₊₁); or
2. store in the non-volatile memory the yawₙ associated with the subsequent coordinate pair of interest (xₙ,yₙ) as a new coordinate sample of interest and yawₙ as a new last yaw of interest if the condition is met.

2. The system of claim 1, further comprising instructions to deduplicate a redundant coordinate sample over the time interval and detecting a user initiated hover in place command of a finite duration and discarding one or more coordinate pairs (xₙ,yₙ) during the time interval.

3. The system of claim 2, wherein the instructions to deduplicate the redundant coordinate sample over the time interval further comprise discarding the subsequent second coordinate pair (x₁,y₁) when the first coordinate pair of interest (x₀,y₀) is approximately equal to the subsequent second coordinate pair (x₁,y₁) within a predetermined deviation.

4. The system of claim 3, wherein the instructions to deduplicate the redundant coordinate sample over the time interval further comprises a predetermined deviation over the time interval, wherein the deviation is within a sensor tolerance.

5. The system of claim 1, further comprising a route of coordinate samples (kₙ), wherein the route is based at least in part on a location position sample rate over the time interval; and an instruction to store to the point of interest dataset a minimum number of points of interest based at least in part on dividing the time interval by the sample rate.

6. The system of claim 5, further comprises instructions to store in memory a minimum number of points of interest based at least in part on dividing the time interval by the sample rate.

7. The system of claim 5, wherein a route of coordinate samples (kₙ) is based at least in part on a location position sample rate over the time interval; and wherein the system further comprises instructions to store in memory a minimum number of points of interest based at least in part on dividing the time interval by the sample rate, wherein a RF transceiver is a cellular transceiver.

8. The system of claim 1, wherein the wireless transceiver is a RF transceiver.

9. The system of claim 5, wherein a route of coordinate samples (kₙ) is based at least in part on a location position sample rate over the time interval; the system further comprises:
a. instructions to store in memory a minimum number of points of interest based at least in part on dividing the time interval by the sample rate; and
b, wherein the instruction to calculate an angle of congruence α between the first vector of interest V1 and the candidate vector of interest V2 further comprises instructions to determine whether the angle of congruence α is within a range of congruence.

10. A system for lossy optimization of a return-to-home route, the system comprising:
a. a non-volatile memory;
b. a wireless transceiver;
c. a processor in communication with a non-volatile memory comprising a processor-readable media having thereon a set of executable instructions, configured, when executed, to cause the processor to:
i. receive via the wireless transceiver of coordinate samples (kₙ) over a time interval, wherein each coordinate sample comprises at least two dimensional pairs (x,y) and a vehicle yaw, the two-dimensional pairs (x,y) indicative of a pilot-assisted vehicle path over the time interval;
ii. identify a first coordinate pair of interest (x₀,y₀) and yaw₀, a subsequent second coordinate pair (x₁,y₁), and a third subsequent coordinate pair (x₂,y₂) and yaw₂;
vii. calculate a first vector of interest V1 from the first coordinate pair of interest (x₀,y₀) and the subsequent second coordinate pair (x₁,y₁);
viii. calculate a candidate vector of interest V2 from the subsequent second coordinate pair (x₁,y₁) and the third subsequent coordinate pair (x₂,y₂);
ix. calculate an angle of congruence α between the first vector of interest and the candidate vector of interest V2;
x. determine whether the angle of congruence α is indicative of a large angle change;
1. discard the subsequent second coordinate pair (x₁,y₁);
2. discard the third subsequent coordinate pair (x₂,y₂) if the angle of congruence α is not indicative of the large angle change and storing the first coordinate pair of interest (x₀,y₀) as a last coordinate sample of interest and yaw₀ as a last yaw of interest in the non-volatile memory; or
3. storing change in the non-volatile memory the third subsequent coordinate pair (x₂,y₂) as a last coordinate sample of interest and yaw₂ as a last yaw of interest if the angle of congruence α is indicative of the large angle; and
vii. compare the last yaw of interest to a subsequent yawₙ associated with a subsequent coordinate pair of interest (xₙ,yₙ) to determine whether a yaw condition exceeds five decidegrees and store in the nonvolatile memory the yawₙ associated with the subsequent coordinate pair of interest (xₙ,yₙ) as a new coordinate sample of interest and yawₙ as a new last yaw of interest if the condition is met; and
viii. discard the subsequent coordinate pair of interest (xₙ,yₙ) and subsequent yawₙ if the condition is not met and retrieve a subsequent yawₙ₊₁ associated with a subsequent coordinate pair of interest (xₙ₊₁,yₙ₊₁), or store in the non-volatile memory the yawₙ associated with the subsequent coordinate pair of interest (xₙ,yₙ) as a new coordinate sample of interest and yawₙ as a new last yaw of interest if the condition is met

11. The system of claim 10, further comprising instructions to receive a route, wherein the route further comprises a route of coordinate samples (kₙ) over a time interval, wherein the route of coordinate samples (kₙ) is based at least in part on a pre-recorded pilot-assisted vehicle path over the time interval; and wherein the range of congruence is defined by:
$$1 \geq cos ( α ) = \frac{V 1 - V 2}{\vert V 1 \vert - \vert V 2 \vert} \leq 0.85 .$$

12. The system of claim 10, wherein the instruction to compare the last yaw of interest to a subsequent yawₙ associated with a subsequent coordinate pair of interest (xₙ,yₙ) to determine whether a yaw condition indicates a directional change; and store in the non-volatile memory the yawₙ associated with the subsequent coordinate pair of interest (xₙ,yₙ) as a new coordinate sample of interest and yawₙ as a new last yaw of interest if the condition is met; and the new last yaw of interest if the condition is met indicates a directional change in a horizontal plane of flight.

13. The system of claim 10, further comprising:
a. an instruction to identify a closed loop trajectory wherein the closed loop trajectory comprises a starting coordinate pair (xₛ,yₛ) and ending coordinate pair (xₑ,yₑ), and a plurality of interceding coordinate pairs;
b. store in memory the starting coordinate pair (xₛ,yₛ) as a point of interest;
c. store in memory the ending coordinate pair (xₑ,yₑ) as a second point of interest;
d. discard the plurality of interceding coordinate pairs; and
e. an instruction to store the first coordinate pair of interest and the new coordinate sample of interest to a point of interest dataset.

14. The system of claim 10, further comprising:
a. an instruction to identify a closed loop trajectory wherein the closed loop trajectory comprises a starting coordinate pair (xₛ,yₛ) and ending coordinate pair (xₑ,yₑ), and a plurality of interceding coordinate pairs;
b. store in memory the starting coordinate pair (xₛ,yₛ) as a point of interest;
c. store in memory the ending coordinate pair (xₑ,yₑ) as a second point of interest;
d. discard the plurality of interceding coordinate pairs;
e. an instruction to store the point of interest and the second point of interest to the point of interest dataset;
f. an instruction to generate a return-to home map from the point of interest dataset; and
g. an instruction to receive a user request for the return-to-home map from the point of interest dataset.

15. The system of claim 10, wherein a route of coordinate samples (kₙ) is based at least in part on a location position sample rate over the time interval; and
a. an instruction to store to the point of interest dataset a minimum number of points of interest based at least in part on dividing the time interval by the sample rate further comprising:
b. an instruction to generate a return-to-home map from the point of interest dataset; and
c. a user interface to receive a user request for the return-to home map from the point of interest dataset.

16. A method for lossy optimization of a return-to-home route, the method comprising:
a. receiving a route of coordinate samples (kₙ) over a time interval, wherein each coordinate sample comprises at least two-dimensional pairs (x,y) and a vehicle yaw, the two-dimensional pairs (x,y) indicative of a pilot-assisted vehicle path over the time interval;
b. identifying a first coordinate pair of interest (x₀,y₀) and yaw₀, a subsequent second coordinate pair (x₁,y₁), and a third subsequent coordinate pair (x₂,y₂) and yaw₂;
c. calculating a first vector of interest V1 from the first coordinate pair of interest (x₀,y₀) and the subsequent second coordinate pair (x₁,y₁);
d. calculating a candidate vector of interest V2 from the subsequent second coordinate pair (x₁,y₁) and the third subsequent coordinate pair (x₂,y₂);
e. calculating an angle of congruence α a between the first vector of interest V1 and the candidate vector of interest V2;
f. determining whether the angle of congruence α is indicative of a large angle change;
i. discarding the subsequent second coordinate pair (x₁,y₁);
ii. discarding the third subsequent coordinate pair (x₂,y₂) if the angle of congruence α is not indicative of the large angle change and storing the first coordinate pair of interest (x₀,y₀) as a last coordinate sample of interest and yaw₀ as a last yaw of interest; or
iii. storing the third subsequent coordinate pair (x₂,y₂) as a last coordinate sample of interest and yaw₂ as a last yaw of interest if the angle of congruence α is indicative of the large angle change; and
g. comparing the last yaw of interest to a subsequent yawₙ associated with a subsequent coordinate pair of interest (xₙ,yₙ) to determine whether a yaw condition is met; and
i. discarding the subsequent coordinate pair of interest (xₙ,yₙ) and subsequent yawₙ if the condition is not met and retrieving a subsequent yawₙ₊₁ associated with a subsequent coordinate pair of interest (xₙ₊₁,yₙ₊₁); or
ii. storing the yawₙ associated with the subsequent coordinate pair of interest (xₙ,yₙ) as a new coordinate sample of interest and yawₙ as a new last yaw of interest if the condition is met.

17. The method of claim 15, further comprising deduplicating a redundant coordinate sample over the time interval.

18. The method of claim 15, wherein receiving a route of coordinate samples (kₙ) over a time interval is received from a Ground Control System (GCS).

19. The method of claim 18, further comprising requesting the route of coordinate samples (kₙ) over a time interval is received from a hardwire connect from a library of pre-recorded routes.

20. The method of claim 16, wherein calculating a first vector of interest V1 from the first coordinate pair of interest (x₀,y₀) and the subsequent second coordinate pair (x₁,y₁) further comprises:
and
$$V 1 = [ \begin{matrix}x 0 - x 1 \\ y 0 - y 1\end{matrix} ] . \qquad a$$
$$V 2 = [ \begin{matrix}x 1 - x 2 \\ y 1 - y 2\end{matrix} ] . \qquad b$$
storing the first coordinate pair of interest and the new coordinate sample of interest to a point of interest dataset.
